(19) United States
(12) Patent Application Publication
(10) Pub. No.: US 2008/0171263 A1
(43) Pub. Date: Jul. 17, 2008

(54) NEGATIVE ELECTRODE FOR NONAQUEOUS ELECTROLYTE SECONDARY BATTERY, ITS MANUFACTURING METHOD, AND NONAQUEOUS ELECTROLYTE SECONDARY BATTERY USING THE SAME

(76) Inventors: Masaya Ugaji, Osaka (JP); Masaki Hasegawa, Osaka (JP); Katsumi Kashiwagi, Nara (JP)

Correspondence Address: MCDERMOTT WILL & EMERY LLP, 600 13TH STREET, NW, WASHINGTON, DC, 20005-3096, US

(21) Appl. No.: 11/970,257

(22) Filed: Jan. 7, 2008

(30) Foreign Application Priority Data
Jan. 11, 2007 (JP) 2007-003007
Jan. 11, 2007 (JP) 2007-003008
Aug. 9, 2007 (JP) 2007-207592

(51) Int. Cl. H01M 4/48; H01M 4/04

(52) U.S. Cl. 429/218.1; 429/209; 29/623.5

(57) ABSTRACT

A negative electrode for nonaqueous electrolyte secondary battery comprising a current collector with a concave and a convex formed at least on one surface thereof, and a column member having n (n≧2) stages of laminated columnar portions obliquely formed on the convex of the current collector, wherein a layer being less in expansion and contraction due to insertion and extraction of lithium ion is disposed in the column member.

### BACKGROUND OF THE INVENTION

1. Field of the Invention

The present invention relates to a nonaqueous electrolyte secondary battery excellent in charge/discharge characteristics, and more particularly, it relates to a negative electrode for nonaqueous electrolyte secondary battery which is excellent in high rate characteristic and low temperature characteristic, its manufacturing method, and a nonaqueous electrolyte secondary battery using the same.

2. Background Art

A lithium ion secondary battery representing a nonaqueous electrolyte secondary battery is light-weight and very high in electromotive force and energy density. Therefore, there is an increasing demand for lithium ion secondary battery as a driving power source for various types of portable electronic equipment such as portable telephone, digital camera, video camera, and notebook personal computer, and mobile communication equipment.

A lithium ion secondary battery comprises a positive electrode formed from lithium contained composite oxide, a negative electrode containing lithium metal, lithium alloy or negative electrode active material inserting/extracting lithium ion, and electrolyte.

And, recently, in place of carbon material such as graphite conventionally used as a material for negative electrode, there is a report of study on elements having insertive property of lithium ion and exceeding 833 mAh/cm³ in theoretical capacity density. For example, silicon (Si), tin (Sn), germanium (Ge), oxide and alloy of these can be mentioned as elements of negative electrode active material exceeding 833 mAh/cm³ in theoretical capacity density. Out of these elements, Si particles and silicon containing particles such as silicon oxide particles are widely studied because they are inexpensive.

However, these elements increase in volume when inserting lithium ion during the time of charging. For example, in case of negative electrode active material Si, it is represented by Li_{4.4}Si with lithium ion inserted to maximum, and as it changes from Si to Li_{4.4}Si, the volume increases 4.12 times in charging.

Accordingly, when negative electrode active material is formed by depositing thin film of the element on a current collector by using CVD method or sputtering method in particular, the expansion and contraction of the negative electrode active material takes place due to insertion and extraction of lithium ion, and there is a possibility that peeling occurs due to worsening of tight contact between the negative electrode active material and negative electrode current collector during repetition of the charging/discharging cycle.

In order to solve the above problem, disclosed is Unexamined Japanese Patent Publication No. 2003-17040 (hereinafter referred to as Patent Document 1) wherein the current collector is provided with irregular surfaces, and thin film of negative electrode active material is deposited thereon, and space is formed by etching in the direction of thickness. Also, a method of disposing a mesh above the current collector, and depositing the thin film of negative electrode active material thereon through the mesh, thereby suppressing the deposition of negative electrode active material on an area corresponding to the frame of mesh is proposed in Unexamined Japanese Patent Publication No. 2002-279974 (hereinafter referred to as Patent Document 2).

Also, a method of providing the current collector with irregular surfaces and forming a thin film negative electrode material thereon obliquely of the surface vertical to main surface of the negative electrode material is proposed in Unexamined Japanese Patent Publication No. 2005-196970 (hereinafter referred to as Patent Document 3).

That is, in the case of secondary battery shown in Patent Document 1 and Patent Document 2, thin film of negative electrode active material is formed in columnar shape, and space is formed between the column members in order to prevent peeling or creasing. However, since the negative electrode active material is shrinking at start of charging, the metal surface of the current collector is sometimes exposed via the space. As a result, the exposed current collector confronts the positive electrode at the time of charging, and it gives rise to deposition of lithium metal, causing worsening of the safety and lowering of the capacity. Also, if the negative electrode active material of columnar shape is increased in height or the space interval is decreased in order to increase the battery capacity, then the tip (open side) of columnar negative electrode active material in particular, which is not regulated by the current collector of the like, will expand more as compared with the area around the current collector as the charge goes on. As a result, the columnar negative electrode active materials come in contact with each other at the area near the tip, and due to their pushing each other, the negative electrode active material peels off from the current collector or creases are generated on the current collector. Accordingly, it has been unable to realize the prevention of peeling of the negative electrode active material from the current collector and the generation of creases and the enhancement of capacity at the same time. Further, because the electrolyte is shut up in space between columnar negative electrode active materials expanded and contacted on each other, the movement of lithium ion at the initial stage of discharge is prevented, and there arises a problem of discharge characteristics such as high rate discharge or under low temperatures conditions.

Also, in the structure shown in Patent Document 3, as shown in FIG. 21A, the exposure of current collector 551 and deposition of lithium metal can be prevented by negative electrode active material 553 formed by inclining (O). However, same as in Patent Documents 1 and 2, as shown in FIG. 21B, since negative electrode active materials 553 greatly expand as compared with areas near current collector 551 as the charge goes on, areas near the tips of columnar negative electrode active materials come in contact with each other, and as a result of pushing each other as shown by the arrow in the figure, there arises a problem that peeling of negative electrode active material 553 from current collector 551 or creasing of current collector 551 are liable to take place.

Further, the expansion and contraction of negative electrode active material accompanying charge and discharge, as described above, greatly vary with the ratios of component elements. For example, in the case of negative electrode active material formed of SiOx, when the value of x is very small, the expansion and contraction are great, and therefore, peeling is liable to take place due to the stress especially in case of forming on the interface of the current collector. Consequently, as the charge/discharge cycle goes on, the negative electrode active material is liable to peel off from the convex of current collector surfaces due to the stress, resulting in lowering of the reliability.

Also, the electrolyte is shut up in space 555 between columnar negative electrode active materials expanded and contacted on each other, and therefore, the movement of lithium ion at the initial stage of discharge is prevented, and there arises a problem of discharge characteristics such as high rate discharge or under low temperatures conditions.

### SUMMARY OF THE INVENTION

The present invention is a negative electrode for nonaqueous electrolyte secondary battery, comprising at least a current collector formed with convex and concave on one surface thereof, and a column member having such a structure that columnar portions obliquely formed on the convex of the current collector are laminated in n (n≧2) stages, wherein the column member is provided with a layer being less in expansion and contraction due to insertion and extraction of lithium ion.

Thus, the change in shape of the column member is partially suppressed, maintaining the space between column members, and it is possible to realize a negative electrode ensuring a long lifetime and capable of greatly improving the high rate discharge and low temperature characteristics.

Also, the method of manufacturing the negative electrode for nonaqueous electrolyte secondary battery of the present invention is a method of manufacturing a negative electrode for nonaqueous electrolyte secondary battery which inserts and extracts lithium ion in a reversible fashion, which includes at least a first step for forming concave and convex on one surface of a current collector, a second step for obliquely forming a 1st-stage columnar portion on convex, moving the current collector in such direction that the angle formed by the normal line of evaporation source and current collector becomes larger, and a third step for obliquely forming a 2nd-stage columnar portion in the direction different from the oblique direction of the 1st-stage columnar portion, wherein the second step and the third step are repeated once at least to form a column member having n (n≧2) stages of which the columnar portions at the odd-numbered stages and even-numbered stages are different in oblique direction from each other, and also, at least any one of the steps for forming columnar portions includes a step for forming a layer of less expansion and contraction due to insertion and extraction of lithium ion.

In this way, it is possible to maintain space between column members by partially suppressing the change in shape of column members and to easily manufacture highly reliable negative electrodes free from generation of creases on the current collector even when the theoretical capacity density of the negative electrode active material used exceeds 833 mAh/cm³.

Also, the nonaqueous electrolyte secondary battery of the present invention comprises a negative electrode for the nonaqueous electrolyte secondary battery, a positive electrode capable of inserting and extracting lithium ion in a reversible fashion, and nonaqueous electrolyte. Accordingly, it is possible to manufacture a nonaqueous electrolyte secondary battery which may assure excellent safety and reliability.

### BRIEF DESCRIPTION OF THE DRAWINGS

FIG. 1 is a sectional view of a nonaqueous electrolyte secondary battery in a first exemplary embodiment of the present invention.

FIG. 2A is a partially schematic sectional view showing the structure of a negative electrode in the first exemplary embodiment of the present invention.

FIG. 2B is a schematic sectional view for describing the condition in charging of a negative electrode in the first exemplary embodiment of the present invention.

FIG. 3A is a partially sectional schematic view showing the condition before charging of a nonaqueous electrolyte secondary battery in the first exemplary embodiment of the present invention.

FIG. 3B is a partially sectional schematic view showing the condition after charging of a nonaqueous electrolyte secondary battery in the first exemplary embodiment of the present invention.

FIG. 4A to FIG. 4D are partially sectional schematic view for describing a method of manufacturing column members formed of n stages of columnar portions of a negative electrode for nonaqueous electrolyte secondary battery in the first exemplary embodiment of the present invention.

FIG. 5A to FIG. 5C are partially sectional schematic view for describing a method of manufacturing column members formed of n stages of columnar portions of a negative electrode for nonaqueous electrolyte secondary battery in the first exemplary embodiment of the present invention.

FIG. 6 is a schematic view for describing a manufacturing apparatus for forming column members of a negative electrode for nonaqueous electrolyte secondary battery in the first exemplary embodiment of the present invention.

FIG. 7 is a partially sectional schematic view showing the structure of other example 1 of a negative electrode for nonaqueous electrolyte secondary battery in the first exemplary embodiment of the present invention.

FIG. 8 is a partially sectional schematic view showing the structure of other example 2 of a negative electrode for nonaqueous electrolyte secondary battery in the first exemplary embodiment of the present invention.

FIG. 9 is a partially sectional schematic view showing the structure of other example 3 of a negative electrode for nonaqueous electrolyte secondary battery in the first exemplary embodiment of the present invention.

FIG. 10A is a partially sectional schematic view showing the structure of a negative electrode in the first exemplary embodiment of the present invention.

FIG. 10B is a schematic view for describing the change of value x in the width direction of active material of each columnar portion in a second exemplary embodiment of the present invention.

FIG. 10C is a schematic view for describing the change of value x in the height direction of active material of each columnar portion in the second exemplary embodiment of the present invention.

FIG. 11A is a partially sectional schematic view showing the condition before charging of a nonaqueous electrolyte secondary battery in the second exemplary embodiment of the present invention.

FIG. 11B is a partially sectional schematic view showing the condition after charging of a nonaqueous electrolyte secondary battery in the second exemplary embodiment of the present invention.

FIG. 12A is a partially sectional schematic view showing the condition before charging of column members of a negative electrode in the second exemplary embodiment of the present invention.

FIG. 12B is a partially sectional schematic view showing the condition after charging of column members of a negative electrode in the second exemplary embodiment of the present invention.

FIG. 13A to FIG. 13E are partially sectional schematic view for describing a method of manufacturing column members formed of n stages of columnar portions of a negative electrode for nonaqueous electrolyte secondary battery in the second exemplary embodiment of the present invention.

FIG. 14 is a schematic view for describing a manufacturing apparatus for forming column members formed of n stages of columnar portions of a negative electrode for nonaqueous electrolyte secondary battery in the second exemplary embodiment of the present invention.

FIG. 15A is a partially sectional schematic view showing the structure of a negative electrode in the second exemplary embodiment of the present invention.

FIG. 15B is a schematic view for describing the change of value x in the width direction of active material of each columnar portion in the second exemplary embodiment of the present invention.

FIG. 15C is a schematic view for describing the change of value x in the height direction of active material of each columnar portion in the second exemplary embodiment of the present invention.

FIG. 16A is a partially sectional schematic view showing the structure of a negative electrode in a third exemplary embodiment of the present invention.

FIG. 16B is a schematic view for describing the change of value x in the width direction of active material of each columnar portion in the third exemplary embodiment of the present invention.

FIG. 16C is a schematic view for describing the change of value x in the height direction of active material of each columnar portion in the third exemplary embodiment of the present invention.

FIG. 17A is a partially sectional schematic view showing the condition before charging of a nonaqueous electrolyte secondary battery in the third exemplary embodiment of the present invention.

FIG. 17B is a partially sectional schematic view showing the condition after charging of a nonaqueous electrolyte secondary battery in the third exemplary embodiment of the present invention.

FIG. 18A to FIG. 18D are partially sectional schematic views for describing a method of manufacturing column members formed of n stages of columnar portions of a negative electrode for nonaqueous electrolyte secondary battery in the third exemplary embodiment of the present invention.

FIG. 19A and FIG. 19B are partially sectional schematic views for describing a method of manufacturing column members formed of n stages of columnar portions of a negative electrode for nonaqueous electrolyte secondary battery in the third exemplary embodiment of the present invention.

FIG. 20 is a diagram showing an example of charge/discharge cycle characteristic in the samples of an embodied example and a comparative example.

FIG. 21A is a partially sectional schematic view showing the structure of a conventional negative electrode before charge.

FIG. 21B is a partially sectional schematic view showing the structure of a conventional negative electrode after charge.

### DETAILED DESCRIPTION OF THE INVENTION

An exemplary embodiments of the present invention will be described in the following with reference to the drawings, giving same reference numerals to same component parts. The present invention is not limited to the contents mentioned in the following provided that it is based on the basic features mentioned in this specification.

### First Exemplary Embodiment

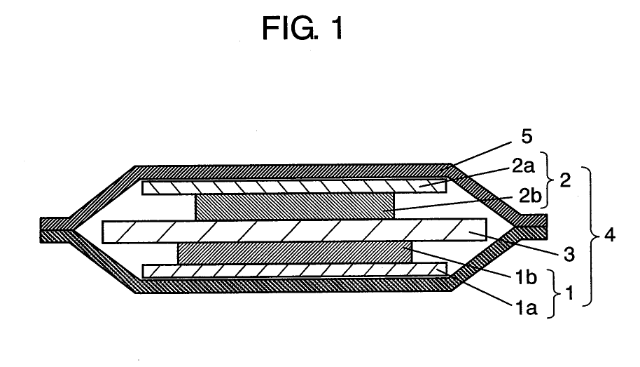

FIG. 1 is a sectional view of a nonaqueous electrolyte second battery in the first exemplary embodiment of the present invention.

As shown in FIG. 1, the laminate type nonaqueous electrolyte secondary battery (hereinafter referred to as battery) is provided, as described in detail later, with negative electrode 1, positive electrode 2 for reduction of lithium ion during discharge, which is opposed to negative electrode 1, and electrode group 4 formed of porous separator 3 disposed therebetween to prevent negative electrode 1 and positive electrode 2 from coming into direct contact with each other. Electrode group 4 and nonaqueous electrolyte (not shown) having lithium ion conductivity are housed in outer case 5. The nonaqueous electrolyte having lithium ion conductivity is contained in separator 3. Also, positive electrode current collector 2a and negative electrode current collector 1a are connected with one end of positive electrode lead (not shown) and negative lead (not shown), and the other end is led outside the outer case 5. Further, the opening of outer case 5 is sealed by resin material. And, positive electrode 2 is formed of positive electrode current collector 2a and positive mixture layer 2b held by positive electrode current collector 2a.

Further, as described in detail later, negative electrode 1 is formed of negative electrode current collector 1a having concave and convex, and column member 1b having such a structure that at least n (n≧2) stages of columnar portions obliquely disposed on the convex of negative electrode current collector 1a are folded and laminated, for example, in a zigzag fashion.

And, the column member is provided with a layer being less in expansion and contraction with respect to insertion and extraction of lithium ion. Here, a layer being less in expansion and contraction means that expansion and contraction are less with respect to insertion and extraction of lithium ion as compared with a portion or layer other than the layer being less in expansion and contraction of the column member. Specifically, it is a layer being less in expansion and contraction with respect to the amount of lithium ion inserted and extracted. The same holds true in the following description.

A layer being less in expansion and contraction is disposed at least between columnar portions, at least in one columnar portion, or on a columnar portion. In this case, it is preferable to form the layer being less in expansion and contraction, for example, by sequentially changing the element containing ratio of the negative electrode active material of the column member. For example, when the columnar portion is a negative electrode active material formed of silicon contained SiOx, the value x of the area in the vicinity of the layer being less in expansion and contraction is increased to make it larger than the value x of other columnar portion, that is, the constitutional ratio of oxygen (O) being a constitutive element is increased to form the layer.

Also, a columnar portion having n (n≧2) stages of laminated layers is preferable to be formed in such manner that the directions of change in element containing ratio are different between the odd-numbered stage and the even-numbered stage.

Here, positive electrode mixture layer 2b includes LiCoO₂ or LiNiO₂, Li₂MnO₄, or lithium contained composite oxide such as mixed or composite compound of these as positive electrode active material. As positive electrode active material other than these, it is also possible to use olivine type lithium phosphate represented by a general formula of LiMPO₄ (M=V, Fe, Ni, Mn), and lithium fluorophosphate represented by a general formula of Li₂ MPO₄F (M=V, Fe, Ni, Mn). Further, it is preferable to substitute a part of the lithium contained compound with a different type of element. It is also preferable to perform surface treatment with metal oxide, lithium oxide, electro-conductive agent and the like, or to perform hydrophobic treatment of surfaces.

Positive electrode mixture layer 2b further includes a conductive agent and binder. As the conductive agent, it is possible to use graphite such as natural graphite and artificial graphite, carbon black such as acetylene black, ketchen black, channel black, furnace black, lamp black, and thermal black, conductive fiber such as carbon fiber and metal fiber, metal powder such as carbon fluoride and aluminum, conductive whisker such as zinc oxide and potassium titanate, conductive metal oxide such as titanium oxide, and organic conductive material such as phenylene derivative.

Also, as the binder, it is possible to use, for example, PVDF, polytetrafluoroethylene, polyethylene, polypropylene, aramid resin, polyamide, polyimide, polyamde-imide, polyacrylnitrile, polyacrylic acid, methyl ester polyacrylate, ethyl ester polyacrylate, hexyl ester polyacrylate, polymetaacrylic acid, methyl ester polymetaacrylate, ethyl ester polymetaacrylate, hexyl ester polymetaacrylate, polyvinyl acetate, polyvinyl pyrrolidone, polyether, polyether sulfone, hexafluoropolypropylene, styrene butadiene rubber, and carboxymethyl cellulose. Also, it is preferable to use copolymer of two or more kinds of material selected from among tetrafluoroethylene, hexafluoroethylene, hexafluoroprolpylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Also, it is preferable to use a mixture of two or more kinds selected out of these materials.

As positive electrode current collector 2a used for positive electrode 2, it is possible to use aluminum (Al), carbon, conductive resin or the like. Also, it is preferable to use any of these materials surface-treated with carbon or the like.

For nonaqueous electrolyte, it is possible to use an electrolyte solution with a solute dissolved in organic solvent or so-called polymer electrolyte layer immobilized by polymer including the solution. When electrolyte solution is used at least, it is preferable to use separator 3 such as non-woven cloth or fine porous film formed of polyethylene, polypropylene, aramid resin, amidimid, polyphenylene sulfide, polyimide, etc. between positive electrode 2 and negative electrode 1 and to impregnate it with electrolyte solution. Also, the inside or surface of separator 3 is preferable to include a heat resisting filler such as alumina, magnesia, silica, and titania. Besides separator 3, it is preferable to dispose a heat resisting layer formed by the filler and same binder as used for positive electrode 2 and negative electrode 1.

As nonaqueous electrolyte material, it is selected in accordance with the oxidation-reduction potential of each active material. As a solute preferable to be used for nonaqueous electrolyte, it is possible to use salts generally used in lithium battery such as LiPF₆, LiBF₄, LiClO₄, LiACl₄, LiSbF₆, LiSCN, LiCF₃SO₃, LiNCF₃CO₂, LiAsF₆, LiB₁₀Cl₁₀, lower aliphatic lithium carboxylate, LiF, LiCl, LiBr, LiI, chloroborane lithium, borates such as bis(1,2-benzenediolate (2-)-0,0′) lithium borate, bis(2,3-naphthalenediolate (2-)—O,O′) lithium borate, bis(2,3-naphthalenediolate (2-)—O,O′) lithium borate, bis(2,2′-biphenyldiolate (2-)—O,O′) lithium borate, bis(5-fluoro-2-olate-1-venzene sulfonic acid-O,O′) lithium borate, and (CF₃SO₂)₂NLi, LiN(CF₃SO₂)(C₄F₉SO₂), (C₂F₅SO₂)₂NLi, tetraphenyl lithium borate.

Further, as organic solvent in which the above salts are dissolved, it is preferable to use a solvent generally used in a lithium battery such as one kind or a mixture of more kinds of solvents such as ethylene carbonate (EC), propylene carbonate, butylene carbonate, vinylene carbonate, dimethyl carbonate (DMC), diethyl carbonate, ethylmethyl carbonate (EMC), dipropyl carbonate, methyl formate, methyl acetate, methyl propionate, ethyl propionate, dimethoxy methane, γ-prothyrolactone, γ-valerolactone, 1,2-diethoxy ethane, 1,2-dimethoxy ethane, ethoxy-methoxy ethane, trimethoxy methane, tetrahydrofuran derivatives such as tetrahydrofuran, 2-methyl tetrahydrofuran, dimethyl sulfoxide, dioxolane derivatives such as 1,3-dioxolane, 4-methyl 1,3-dioxolane, formamide, acetoamide, dimethyl formamide, acetonitrile, propynitrile, nitromethane, ethylmonoglyme, triester phosphate, ester acetate, ester propionate, sulforan, 3-methyl sulforan, 1,3-dimethyl-2-imidazolidinon, 3-methyl-2-oxazolidinon, propylene carbonate derivative, ethyl ether, diethyl ether, 1,3-propanesalton, anysol, fluorobenzene.

Further, it is preferable to include additives such as vinylene carbonate, cyclohexyl benzene, biphenyl, diphenyl ether, vinyl ethylene carbonate, divinyl ethylene carbonate, phenyl ethylene carbonate, diacryl carbonate, fluoroethylene carbonate, catechol carbonate, vinyl acetate, ethylene sulfite, propane saltone, trifluoropropylene carbonate, dibenzofuran, 2,4-difluoroanysole, o-turphenyl, and m-turphenyl.

It is preferable to use nonaqueous electrolyte in the form of solid electrolyte by mixing the above solvent in one kind or a mixture of more kinds of polymer such as polyethlene oxide, polypropylene oxide, polyphosphazene, polyaziridine, polyethylene sulfide, polyvinyl alcohol, polyfluorovinylidene, and polyhexafluoropropylene. Also, it is preferable to mix the solute with the organic solvent to use it in the form of gel. Further, it is preferable to use organic materials such as lithium nitride, lithium halide, lithium oxygen acid, Li₄SiO₄, Li₄SiO₄—LiI—LiOH, Li₃PO₄—Li4SiO₄, Li₂SiS₃, Li₃PO₄—Li₂S—SiS₂, and phosphor sulfide compound as solid electrolyte. In the case of using nonaqueous electrolyte gel, it is preferable to dispose the nonaqueous electrolyte gel between negative electrode 1 and positive electrode 2 in place of separator 3. Or, it is preferable to make the arrangement so that nonaqueous electrolyte gel is adjacent to separator 3.

And, metallic foil of stainless steel, nickel, copper, and titanium or thin film of carbon or conductive resin is used for negative electrode current collector 1a of negative electrode 1. Further, it is preferable to treat the surface with carbon, nickel, titanium or the like.

Also, as a columnar portion of column member 1b of negative electrode 1, it is possible to use negative electrode active material such as silicon (Si) or tin (Sn) whose theoretical capacity density for reversible insertion and extraction of lithium ion exceeds 833 mAh/cm³. Such an active material is able to bring about the advantages of the present invention irrespective of whether it is simple, alloy, compound, solid solution, and composite active material including silicon contained material or tin contained material. That is, as silicon contained material, it is possible to use alloy, compound or solid solution, partially substituting Si with at least one element selected from a group consisting of Al, In, Cd, Bi, Sb, B, Mg, Ni, Ti, Mo, Co, Ca, Cr, Cu, Fe, Mn, Nb, Ta, V, W, Zn, C, N, Sn with respect to Si, SiOx (0≦x≦2.0) or any one of these. As tin contained material, Ni₂Sn₄, Mg₂Sn, SnOx (0≦x≦2.0), SnO₂, SnSiO₃, LiSnO can be applied.

These negative electrode active materials can be individually configured, but it is also possible to configure by using a plurality of negative electrode active materials. As an example of configuring a plurality of negative electrode active materials, compound containing Si, oxygen and nitrogen, and composite material of a plurality of compounds including Si and oxygen which are different in composition ratio of Si and oxygen can be mentioned.

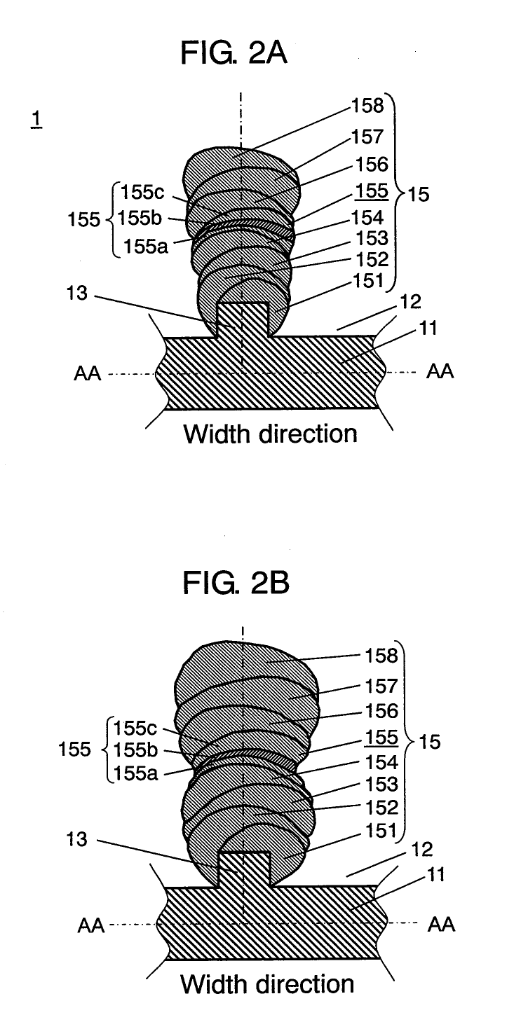

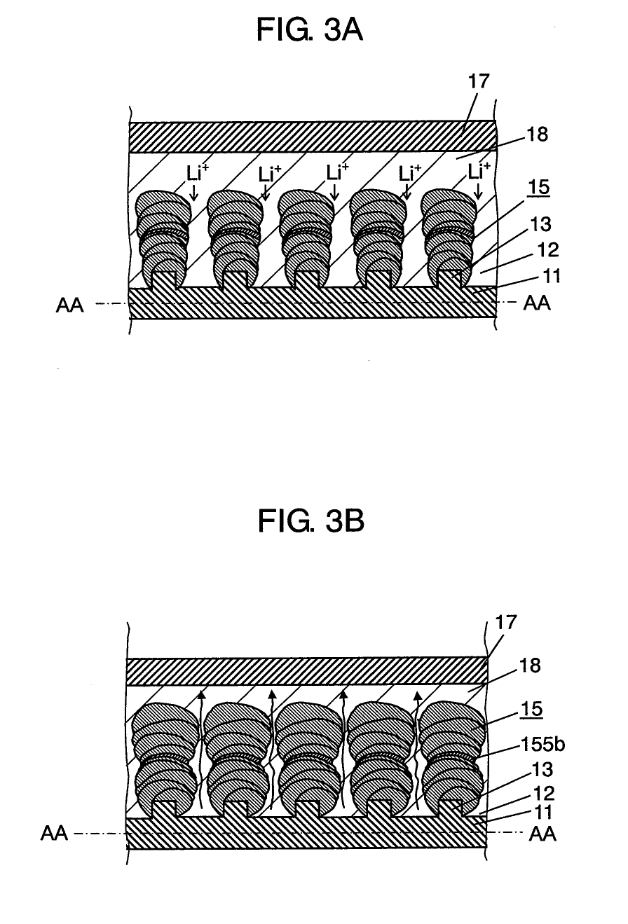

The negative electrode for nonaqueous electrolyte secondary battery (hereinafter often referred to as negative electrode) in the first exemplary embodiment of the present invention will be described in the following by using FIG. 2A to FIG. 3B. In the following, for example, negative electrode active material (hereinafter referred to as active material) that can be represented by SiOx (0≦x≦2.0) at least including silicon is described, but the present invention is not limited to this.

FIG. 2A is a partially sectional schematic view showing the structure of the negative electrode in the first exemplary embodiment of the present invention. FIG. 2B is a partially sectional schematic view for describing the condition of the negative electrode during charge in the first exemplary embodiment of the present invention.

As shown in FIG. 2A, at least the upper surface of negative electrode current collector (hereinafter referred to as current collector) 11 made of conductive metal material such as copper (Cu) is provided with concave 12 and convex 13. And, on the top of convex 13 is formed an active material represented by SiOx of negative electrode 1, for example, by an oblique evaporation method using a sputtering method or vacuum evaporation method in such manner that n (n≧2) stages of columnar portions are obliquely laminated to form column member 15.

An example of column member 15 formed by laminating n=8 stages of first columnar portion 151 to eighth columnar portion 158 in a folded state will be specifically described in the following, and just required is n≧2, but the present invention is not limited to this.

Firstly, first columnar portion 151 of column member 15 is formed so that cross angle (hereinafter referred to as oblique angle) θ₁ (not shown) is formed by a center line (not shown) in the oblique direction of first columnar portion 151 and center line (AA-AA) in the thickness direction of current collector 11 at least on concave 13 of current collector 11. And, second columnar portion 152 of column member 15 is formed on first columnar portion 151 in such manner that the oblique direction is different from the oblique direction of first columnar portion 151, for example, forming oblique angle θ₂ (not shown) (180 deg.-θ₁). Similarly, third columnar portion 153, fifth columnar portion 155, and seventh columnar portion 157 at the odd-numbered stages are formed in the same direction as the oblique direction of first columnar portion 151, while fourth columnar portion 154, sixth columnar portion 156, and eighth columnar portion 158 at the even-numbered stages are formed in the same direction as the oblique direction of second columnar portion 152, thereby forming column member 15. In this case, the oblique direction of each columnar portion is allowable to be same or different provided that it is within 90 deg.

Here, fifth columnar portion 155 of column member 15 is, for example, formed of layer 155b being larger in value x of active material formed of SiOx and less in expansion and contraction against insertion and extraction of lithium ion, and layers 155a, 155c being smaller in value x than the layer, that is, being greater in expansion and contraction against insertion and extraction of lithium ion. In this case, value x of portions other than layer 155b being less in expansion and contraction of column member 15 is allowable to be same or different in width direction or height direction for example, provided that it is smaller than value x of layer 155b being less in expansion and contraction, and it is allowable to form the layer, changing the value of x inside each columnar portion.

In the negative electrode having column member 15 configured as described above, column member 15 except layer 155b being less in expansion and contraction due to insertion of lithium ion expands during charge, as shown in FIG. 2B. Generally, when layer 155b being less in expansion and contraction is not formed, expansion occurs, for example, in a reversed conical shape upwardly from convex 13 of current collector 11, but as the expansion is suppressed by layer 155b being less in expansion and contraction, for example, expansion takes place in a drum-like shape with layer 155b being less in expansion and contraction held therebetween. As a result, contacting with each other of column members 15 in the vicinity of upper end portion can be prevented or lessened, and it is possible to suppress peeling and cracking of column member 15 or creasing and deforming of the current collector, to ensure a longer life of cycle characteristic, and to realize a negative electrode excellent in reliability and battery characteristics such as high rate discharge and low temperature characteristics.

In FIG. 2A, with respect to layer 155b being less in expansion and contraction and layer 155a, 155c being greater in expansion and contraction, they are clearly different in the value of x in the figure, but the present invention is not limited to this. For example, it is preferable to change the value of x sequentially from layer 155b being less in expansion and contraction toward layer 155a, 155c being greater in expansion and contraction. In this way, it is possible to further improve the reliability without concentration of stresses of expansion and contraction on the interface.

Also, in the present exemplary embodiment, an example of forming one layer 155b being less in expansion and contraction on column member 15 is described, but the present invention is not limited to this. For example, it is preferable to form the layer in a plurality of columnar portions or on the entire columnar portion. Thus, the change in shape of the column member can be optionally suppressed, and the design freedom can be greatly enhanced with respect to the height and intervals of column members.

The operation in charging of the secondary battery formed by using the negative electrode for nonaqueous electrolyte secondary battery of the present exemplary embodiment will be described by using FIG. 3A and FIG. 3B.

FIG. 3A is a partially sectional schematic view showing the before-charge condition of the nonaqueous electrolyte secondary battery in the first exemplary embodiment of the present invention. FIG. 3B is a partially sectional schematic view showing the after-charge condition of the nonaqueous electrolyte secondary battery in the first exemplary embodiment of the present invention.

In column member 15 with n=8 stages of columnar portions obliquely formed on convex 13 of current collector 11, the volume of column member 15 except layer 155b being less in expansion and contraction expands due to insertion of lithium during the charging of nonaqueous electrolyte secondary battery. As a result, as shown in FIG. 3B, the change in shape is suppressed by layer 155b being less in expansion and contraction, then expansion occurs in a drum-like form at the top and bottom thereof. Contrarily, due to discharge of lithium ion, as shown in FIG. 3A, the volume of the column member expanded in a drum-like form contracts to obtain the initial state of column member 15.

In that case, as shown in FIG. 3B, the expansion of column member 15 expanded due to charging is suppressed by layer 155b being less in expansion and contraction. As a result, adjacent column members 15 are prevented from coming in contact with each other, and electrolyte solution 18 formed of nonaqueous electrolyte is able to easily move between column members 15 as shown by the arrow in the figure. Also, electrolyte solution 18 between column members 15 is easy to convectively circulate through the space between column members 15, and there is no hindrance to the movement of lithium ion. Consequently, it is possible to greatly improve the discharge characteristics at the time of high rate discharge and low temperatures.

As described above, for example, inside a column member formed from SiOx, a layer being less in expansion and contraction with element composition ratio increased (value of x), suppressing the change in shape of column member, and thereby, it is possible to prevent the column members from coming into contract with each other in charge/discharge cycle and to realize a hard-to-peel and highly reliable negative electrode.

According to the first exemplary embodiment of the present invention, it is possible to assure a higher capacity and also to sustain a high capacity rate in the charge/discharge cycle. In addition, it is possible to manufacture a nonaqueous electrolyte secondary battery having excellent reliability without generation of peeling of the column member or creasing of the current collector due to contacting of column members with each other.

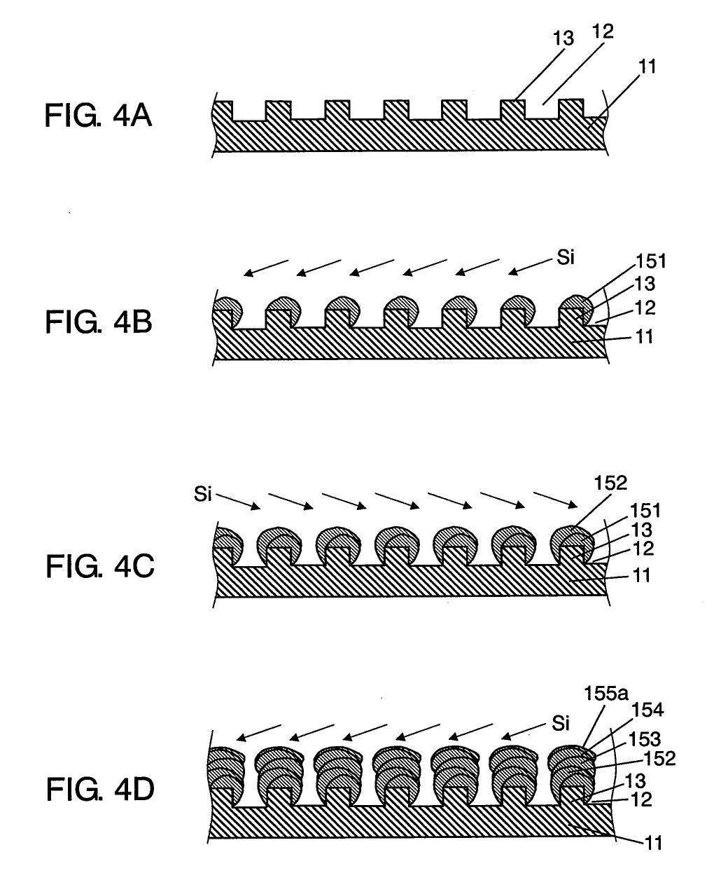

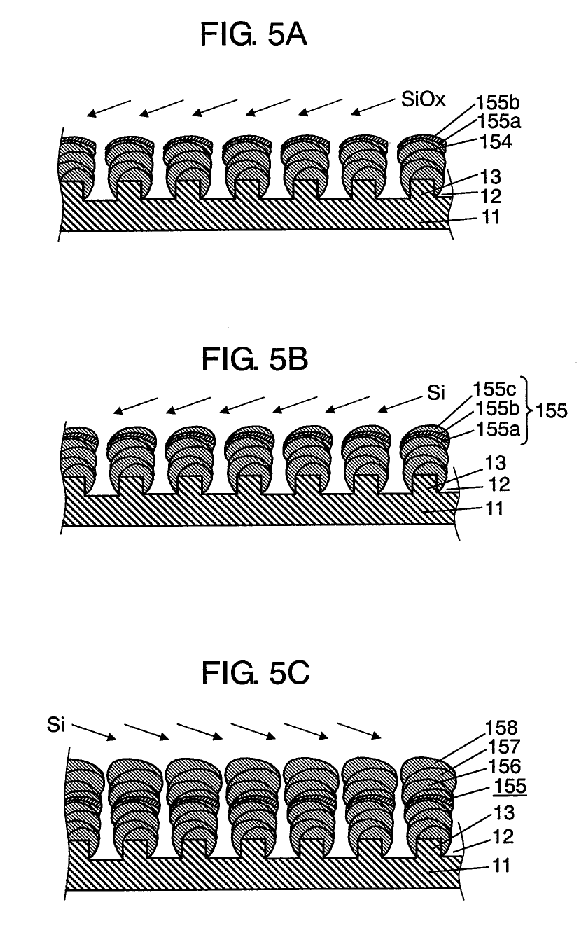

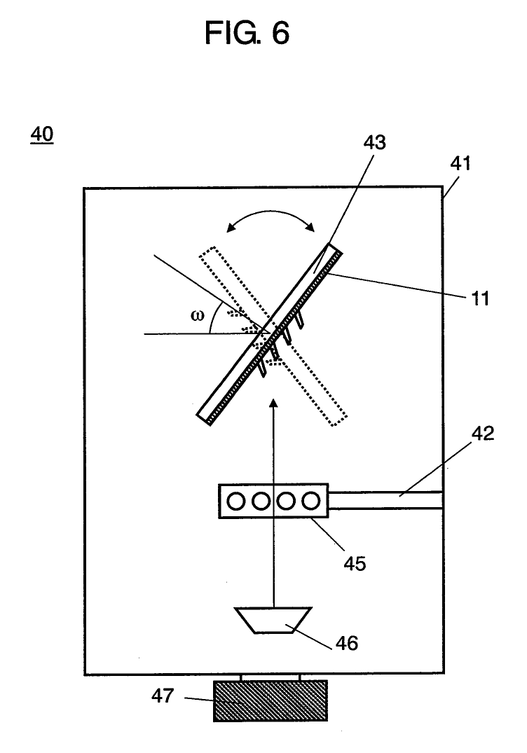

The method of manufacturing a column member of a negative electrode for nonaqueous electrolyte secondary battery in the first exemplary embodiment of the present invention will be described in detail in the following by using FIG. 4A to FIG. 4D, FIG. 5A to FIG. 5C, and FIG. 6.

FIG. 4A to FIG. 4D, and FIG. 5A to FIG. 5C are partially sectional schematic views for describing the method of manufacturing a column member formed of n stages of columnar portions of the nonaqueous electrolyte secondary battery in the first exemplary embodiment of the present invention. FIG. 6 is a schematic view for describing the manufacturing apparatus. In the following, an example of column member formed of n=8 stages of columnar portions is described.

Manufacturing apparatus 40 for forming a column member shown in FIG. 6 comprises an electron beam (not shown) that is a heating means in vacuum chamber 41, gas intake pipe 42 for taking oxygen gas into vacuum chamber 41, and fixing member 43 for fixing the current collector, in which the pressure is reduced by vacuum pump 47. Gas intake pipe 42 has nozzle 45 for discharging oxygen gas into vacuum chamber 41, and fixing member 43 for retaining the current collector is disposed above the nozzle 45. Also, evaporation source 46 deposited on the surface of current collector to form a column member is installed just under fixing member 43. And, in manufacturing apparatus 40, it is possible to change the positional relation between the current collector and evaporation source 46 according to the angle of fixing member 43. That is, the oblique direction of each stage of the column member formed of n stages is controlled by moving fixing member 43 to change the angle ω formed by the normal line direction of the current collector surface and the horizontal direction.

For the manufacturing apparatus, an example of manufacturing a column member by forming n stages of columnar portions on one surface of the current collector is shown. Actually, however, column members are formed on both sides of the current collector in general.

First, as shown in FIG. 4A and FIG. 6, using strip-shaped electrolytic copper foil of 30 μm in thickness, concave 12 and convex 13 are formed on the surface thereof by using a plating method in order to make current collector 11 with convex 13 formed, for example, with height 75 μm, width 10 μm, and interval 20 μm (1st step). And, current collector 11 is disposed on fixing member 43 shown in FIG. 6.

Next, as shown in FIG. 4B and FIG. 6, with the normal line direction of current collector 11 on fixing member 43 set to angle ω (60 deg. for example) to evaporation source 46, an active material such as Si (scrap silicon: purity 99.999%) for example is evaporated by heating with electron beam, which is then applied onto convex 13 of current collector 11 in the direction of arrow in FIG. 4B. In this case, for example, the internal vacuum level of vacuum chamber 41 is set to about pressure 4×10⁻² Pa. In this way, first columnar portion 151 of 3 μm thick by active material Si forms in the oblique direction for example, at angle θ₁ on convex 13 of current collector 11 secured on fixing member 43 disposed at angle ω (2nd step).

Next, as shown in FIG. 4C and FIG. 6, current collector 11 with first columnar portion 151 formed on convex 13 is disposed in a position with the normal line direction of current collector 11 set at angle (180-ω) (120 deg. for example) by turning fixing member 43 as shown by broken line in the figure. And, an active material such as Si (scrap silicon: purity 99.999%) is evaporated from evaporation source 46, which is then applied onto first columnar portion 151 of current collector 11 from the arrow-marked direction in FIG. 4C. In this case, the internal vacuum level of vacuum chamber 41 is for example about pressure 4×10⁻² Pa. Thus, second columnar portion 152 of 3 μm thick (high) by active material Si forms in the oblique direction for example, at angle θ₂ on first columnar portion 151 (3rd step). In this case, first columnar portion 151 and second columnar portion 152 are different in the oblique angle and the oblique direction with respect to the surface direction of current collector 11.

Next, as shown in FIG. 4D and FIG. 6, third columnar portion 153 and fourth columnar portion 154 are formed on second columnar portion 152 by repeating the steps in FIG. 4B and FIG. 4C. And, by using the same method as in FIG. 4B, layer 155a being greater in expansion and contraction is formed on fourth columnar portion 154 by active material Si configuring a part of the fifth columnar portion.

Next, as shown in FIG. 5A and FIG. 6, active material SiOx is formed into layer 155b being less in expansion and contraction on layer 155a being greater in expansion and contraction by using the following method.

Firstly, an active material such as Si (scrap silicon: purity 99.999%) for example is evaporated from evaporation source 46 and is applied onto layer 155a being greater in expansion and contraction from the arrow-marked direction in FIG. 5A. In this case, oxygen (O₂) gas is taken into vacuum chamber 41 from gas intake pipe 42 and is supplied from nozzle 45 toward current collector 11. And, for example, the oxygen atmosphere in vacuum chamber 41 is about pressure 1.3×10⁻¹ Pa. In this way, for example, layer 155b being less in expansion and contraction is formed by active material SiOx with Si bonded to oxygen up to about x=1.8.

Next, as shown in FIG. 5B, by the same method as in FIG. 4D, layer 155c being greater in expansion and contraction is formed on layer 155b being less in expansion and contraction by active material Si configuring a part of the fifth columnar portion. In this way, fifth columnar portion 155 is formed with layer 115b being less in expansion and contraction held between layers 155a, 155c being greater in expansion and contraction.

Subsequently, as shown in FIG. 5C, sixth columnar portion 156 to eighth columnar portion 158 of 3 μm thick (high) in the oblique direction are formed by repeating the 2nd step in FIG. 4B and the 3rd step in FIG. 4C.

Through the above steps, column member 15 formed of first columnar portion 151 to eighth columnar portion 158 and at least partially having layer 155b being less in expansion and contraction is formed. In this case, as shown in FIG. 2A and FIG. 2B, first columnar portion 151, third columnar portion 153, fifth columnar portion 155, and seventh columnar portion 157 at the odd-numbered stages are different in the oblique angle and oblique direction from second columnar portion 152, fourth columnar portion 154, sixth columnar portion 156, and eighth columnar portion 158 at the even-numbered stages.

In the above description, except layer 155b being less in expansion and contraction of column member 15, an example of forming each columnar portion without oxygen is described, but the present invention is not limited to this. For example, it is preferable to use an active material having smaller value x than the value x of layer 155b being less in expansion and contraction. In this way, it is possible to improve the reliability, decreasing the stresses on the interface of layer 155b being less in expansion and contraction.

Thus, negative electrode 1 having column member 15 formed of n=8 stages of columnar portions is fabricated.

In the above description, an example of a column member formed of n=8 stages of columnar portions is described, but the present invention is not limited to this, but it is preferable to form a column member formed of optional n (n≧2) stages of columnar portions.

Also, in the above description, an example of forming one layer 155b being less in expansion and contraction on column member 15 is described, but the present invention is not limited to this. For example, it is also preferable to form a plurality of layers internally of columnar portions or over the entire columnar portion.

Also, in the above manufacturing apparatus, an example of fabricating a column member on a current collector having a specified size, but the present invention is not limited to this, but it is possible to configure various types of apparatuses. For example, it is also preferable to fabricate n stages of column members by disposing a roll-shaped current collector between a feed roll and a take-up roll, disposing a plurality of film depositing rolls in series therebetween, while moving the current collector in one direction. Further, after forming a column member on one surface of a current collector, it is preferable to form a column member on the other surface of the current collector by reversing the current collector. In this way, it is possible to manufacture a negative electrode with excellent productivity.

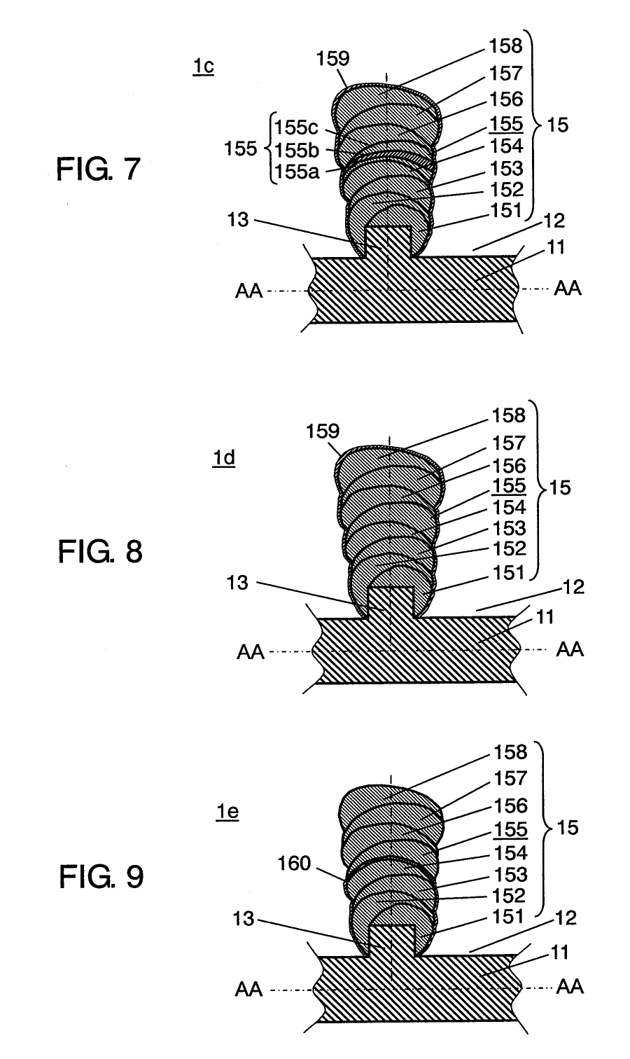

Other examples of negative electrode for nonaqueous electrolyte secondary battery in the first exemplary embodiment of the present invention will be described in the following by using FIG. 7, FIG. 8 and FIG. 9.

FIG. 7 is a partially sectional schematic view showing the structure of other example 1 of the negative electrode for nonaqueous electrolyte secondary battery in the first exemplary embodiment of the present invention. FIG. 8 is a partially sectional schematic view showing the structure of other example 2 of negative electrode for nonaqueous electrolyte secondary battery in the first exemplary embodiment of the present invention. FIG. 9 is a partially sectional schematic view showing the structure of other example 3 of negative electrode for nonaqueous electrolyte secondary battery in the first exemplary embodiment of the present invention.

Negative electrode 1c shown in FIG. 7 is different from negative electrode 1 in such point that layer 159 being less in expansion and contraction is disposed on the outer periphery surface of column member 15.

And, layer 159 being less in expansion and contraction of the outer periphery surface of column member 15 can be formed for example by returning it into the atmosphere from the vacuum chamber after forming negative electrode 1 of the first exemplary embodiment. Also, it is preferable to form a layer being less in expansion and contraction on the outer periphery surface of column member 15 for example by evaporating Si from evaporation source 46, taking in oxygen from nozzle 45, with the angle ω set to 0 deg. to evaporation source 46 of fixing member 43 of manufacturing apparatus 40 shown in FIG. 6.

In this way, the stress on the interface of layer 155b being less in expansion and contraction can be reduced. Further, layer 159 being less in expansion and contraction reduces the stress on the outer periphery surface of the column member, thereby maintaining the space between column members, and it is possible to enhance the high rate discharge and low temperature characteristics in discharging.

Also, negative electrode 1d shown in FIG. 8 is different from negative electrode 1 in such point that layer 159 being less in expansion and contraction is disposed on the outer periphery surface of column member 15, omitting layer 155b being less in expansion and contraction of fifth columnar portion 155.

In this way, the stress on the outer periphery surface of layer 159 being less in expansion and contraction can be reduced, and also, the high rate discharge and low temperature characteristic in discharging can be enhanced by maintaining the space between column members. In this case, even in case cracks are formed as stresses are repeatedly applied to layer 159 being less in expansion and contraction, such cracks serve as passages of electrolyte, and the reliability of the battery can be maintained.

Also, negative electrode 1e shown in FIG. 9 is provided with layer 160 being less in expansion and contraction on the outer periphery surface of a specified columnar portion of column member 15, and it is different from negative electrode 1 in such point that layer 155b being less in expansion and contraction of fifth columnar portion 155 is omitted.

In this way, layer 160 being less in expansion and contraction reduces the stresses on the outer periphery surfaces of first columnar portion 151 to fourth columnar portion 154, and thereby, it is possible to suppress the expansion in the vicinity of current collector between column members and to improve the peeling strength. Further, since the space around the current collector is maintained, the electrolyte solution is able to convectively circulate through the space, and it is possible to enhance the high rate discharge and low temperature characteristic in discharging.

The present exemplary embodiment will be specifically described in the following by using embodied examples. The present invention is not limited to the following embodied examples, but it is possible to execute by changing the materials used provided that the point of the present invention is not changed.

### EMBODIED EXAMPLE 1

Firstly, a negative electrode having a column member formed of n=8 stages of columnar portions by using the manufacturing apparatus shown in FIG. 6. In this case, a layer being less in expansion and contraction is formed on the columnar portion at the fifth stage.

First, as a current collector, strip-shaped electrolytic copper foil of 30 μm thick is used, forming convex of 10 μm in width, 7.5 μm in height, and 20 μm in interval on the surface thereof by using a plating method.

And, using Si as negative electrode active material, and evaporation unit (evaporation source, crucible, electron beam generator in the form of a unit), a first columnar portion formed from for example SiOx of x=0.2 is manufactured. In this case, the internal vacuum level of the vacuum chamber is pressure 4×10⁻² Pa. Also, during evaporation, electron beam generated by an electron beam generator is deflected by a deflecting yoke and applied to the evaporation source. Scrap material (scrap silicon: purity 99.999%) generated during forming of semiconductor wafer is used as evaporation source.

In this case, the columnar portion at the first stage is formed for example 3.0 μm high, adjusting the angle of the fixing member to make the angle ω 60 deg., at a film deposition speed of about 8 nm/s.

And, by using the forming method described in the first exemplary embodiment, the second columnar portion to the fourth columnar portion are formed by 3 μm high each under the same conditions as for the first columnar portion.

Similarly, a layer being greater in expansion and contraction of the fifth columnar portion is formed by about 0.5 μm high under the same conditions as for the first columnar portion. And, a layer being less in expansion and contraction of the fifth columnar portion is formed for example by SiOx of x=1.8, introducing oxygen gas of 99.7% in purity from nozzle 45 into the vacuum chamber. Further, a layer being greater in expansion and contraction of the fifth columnar portion is formed by about 0.5 μm high under the same conditions as for the first columnar portion with the introduction of oxygen gas discontinued, thereby forming the fifth columnar portion.

Also, similarly, the sixth columnar portion to the eighth columnar portion are formed by 3 μm high each under the same conditions as for the first columnar portion.

Through the above steps, a column member formed of n=8 stages having a layer being less in expansion and contraction at the fifth columnar portion is fabricated by 24 μm in height.

The angle of the column member in the negative electrode to the center line of the current collector was evaluated by sectional observation with use of a scanning electronic microscope (Hitachi S-4700), then the result is such that the oblique angle of columnar portion at each stage is about 41 deg. but the column member is formed vertically on the convex of the current collector.

Also, oxygen distribution was checked by using an electron beam probe micro-analyzer (hereinafter referred to as EPMA), measuring the line distribution in the normal line direction of the current collector of columnar portion at each stage of the column member of the negative electrode, then the result is such that in the height direction of each columnar portion, except a layer being less in expansion and contraction, the average oxygen containing ratio (value x) is x=0.18 to x=0.23, and in a layer being less in expansion and contraction, the average oxygen containing ratio (value x) is x=1.85.

Through the above steps, a negative electrode having a column member formed of 8 stages of columnar portions on the convex of the current collector was fabricated.

After that, Li metal of 10 μm was evaporated on the negative electrode surface by a vacuum evaporation method. Further, at the inner periphery side of the negative electrode, an exposed portion was disposed on Cu foil not confronting the positive electrode, and the negative electrode lead made of Cu was welded.

Subsequently, a positive electrode having positive electrode active material capable of inserting and extracting lithium ion was fabricated by the following method.

First, LiCoO₂ powder, positive electrode active material, of 93 parts by weight was mixed with acetylene black, conductive agent, of 4 parts by weight. The powder was mixed with binder, N-methyl-2-pyrolidone (NMP) solution (#1320 of Kureha Chemical) of vinylidene polyfluoride (PVDF), so that the weight of PVDF is 3 parts by weight. An appropriate amount of NMP was added to the mixture to prepare a paste for positive electrode mixture. The paste for positive electrode mixture was applied to both sides of the current collector by using a doctor blade method on a positive electrode current collector (5 μm thick) formed from aluminum (Al) foil, which was then rolled so that the positive electrode mixture layer becomes 3.5 g/cc in density and 160 μm in thickness, followed by sufficient drying at 85° C. and cutting to fabricate a positive electrode. The Al foil not confronting the negative electrode was provided with an exposed portion at the inner periphery of the positive electrode, and the positive electrode lead made of Al was welded.

Negative electrodes and positive electrodes fabricated as described above were laminated via separator formed from porous polypropylene of 25 μm thick, thereby making an electrode group of 40 mm×30 mm square. And, the electrode group was impregnated with the mixed solution of ethylene carbonate/diethyl carbonate of LiPF₆ as electrolyte solution and stored in the outer case (material: aluminum), and the opening of the outer case was sealed to make a laminate type battery. The design capacity of the battery is 21 mAh. The battery is sample 1.

### EMBODIED EXAMPLE 2

A negative electrode was fabricated by the same method as in the embodied example 1 except that a layer being less in expansion and contraction was formed 0.3 μm in thickness on the outer periphery surface of the column member. In this case, the layer being less in expansion and contraction was formed by exposing to the atmosphere, out of the vacuum chamber, after forming the column member.

Except that the above negative electrode is used, the nonaqueous electrolyte secondary battery fabricated by the same method as in the embodied example 1 is sample 2.

### EMBODIED EXAMPLE 3

A layer being less in expansion and contraction is not formed in the column member. After forming n=8 stages of columnar portions by the same method as in the embodied example 1, a layer being less in expansion and contraction was formed 0.3 μm thick on the outer periphery surface of the column member by the same method as in the embodied example 2 to manufacture a negative electrode.

Except that the above negative electrode is used, the nonaqueous electrolyte secondary battery fabricated by the same method as in the embodied example 1 is sample 3.

### EMBODIED EXAMPLE 4

After forming the first columnar portion to the fourth columnar portion by the same method as in the embodied example 1, a layer being less in expansion and contraction was formed 0.3 μm thick on the outer periphery surface thereof by the same method as in the embodied example 2. Further, the fifth columnar portion to the eighth columnar portion were formed by the same method as in the embodied example 1, and a column member forming of n=8 stages was formed to manufacture a negative electrode.

Except that the above negative electrode is used, the nonaqueous electrolyte secondary battery fabricated by the same method as in the embodied example 1 is sample 4.

### COMPARATIVE EXAMPLE 1

Except that n=8 stages of columnar portions are formed 3 μm in height (thickness) on the column member without forming a layer being less in expansion and contraction, a negative electrode was fabricated by the same method as in the embodied example 1.

In this case, the oxygen distribution was checked by measuring the line distribution in the normal line direction of the current collector of the columnar portion at each stage to find that the average oxygen containing ratio (value x) was x=0.18 to x=0.23.

Except that the above negative electrode is used, the nonaqueous electrolyte secondary battery fabricated by the same method as in the embodied example 1 is sample C1.

Each nonaqueous electrolyte secondary battery thus fabricated was evaluated as described in the following.

### (Measurement of Battery Capacity)

Each nonaqueous electrolyte secondary battery was charged and discharged under the following conditions at the environment temperature 25° C. First, the battery was charged until the battery voltage becomes 4.2V with constant current of hour rate 1.0 C (21 mA) with respect to design capacity (21 mAh), and it was charged with constant voltage of 4.2V for attenuating the current to a current value of hour rate 0.05 C (1.05 mA). After that, the operation was suspended for 30 minutes.

After that, the battery was discharged with constant current of hour rate 0.2 C (4.2 mA) until lowering of the battery voltage to 3.0V.

And, the above operation being one cycle, the discharge capacity at the third cycle is regarded as the battery capacity.

### (Charge/Discharge Cycle Characteristics)

Each nonaqueous electrolyte secondary battery was repeatedly charged and discharged under the following conditions at the environment temperature 25° C.

First, the battery was charged until the battery voltage becomes 4.2V with constant current of hour rate 1.0 C (21 mA) with respect to design capacity (21 mAh), and it was charged with constant voltage of 4.2V until lowering of the charging current to the current value of hour rate 0.05 C (1.05 mA). And, the operation was suspended for 30 minutes after charging.

After that, the battery was discharged with constant current of hour rate 0.2 C (4.2 mA) until lowering of the battery voltage to 3.0V. And, the operation was suspended for 30 minutes after discharging.

The above charge/discharge cycle being one cycle, it was repeated 500 times. And, the value represented by percentage of the discharge capacity at the 500th cycle with respect to the discharge capacity at the 1st cycle is capacity sustaining ratio (%). That is, when the capacity sustaining ratio is closer to 100, the charge/discharge cycle characteristic is more excellent.

Also, the value represented by percentage of the discharge capacity in 0.2 C (4.2 mA) discharge with respect to the charge capacity is charge/discharge efficiency (%). Further, the value represented by percentage of the discharge capacity in high rate discharge of 1.0 C (21 mA) with respect to discharge capacity in 0.2 C (4.2 mA) discharge is high rate ratio (%).

And, the capacity sustaining ratio, charge/discharge efficiency, and high rate ratio were measured at the 10th cycle and 500th cycle.

The items and evaluation results of sample 1 to sample 4 and sample C1 are shown in Table 1 and Table 2.

TABLE 1

| | | Columnar | | | | |
|---|---|---|---|---|---|---|
| | | portion | Layer being | Column | Value x of layer | Value x of columnar |
| | | oblique | less in | member | being less in | portion other than |
| | n | angle | expansion | thickness | expansion and | layer being less in |
| | (stages) | (deg.) | and contraction | (μm) | contraction | expansion and contraction |
| Sample 1 | 8 | 41 | n = 5 | 24 | 1.85 | 0.18-0.23 |
| Sample 2 | 8 | 41 | n = 5, outer | 24 | 1.91 | 0.18-0.23 |
| | | | periphery surface | | | |
| Sample 3 | 8 | 41 | Outer periphery | 24 | 1.87 | 0.18-0.23 |
| | | | surface | | | |
| Sample 4 | 8 | 41 | Outer periphery | 24 | 1.83 | 0.18-0.23 |
| | | | surface up | | | |
| | | | to n = 4 | | | |
| Sample C1 | 8 | 41 | — | 24 | — | 0.18-0.23 |

TABLE 2

| | Number of | Charge/ | | Capacity |
|---|---|---|---|---|
| | cycles | discharge | High rate | sustaining |
| | (times) | efficiency (%) | ratio (%) | ratio (%) |
| Sample 1 | 10 | 99.8 | 93 | 100 |
| | 500 | 99.8 | 87 | 78 |
| Sample 2 | 10 | 99.9 | 90 | 100 |
| | 500 | 99.8 | 83 | 81 |
| Sample 3 | 10 | 99.9 | 90 | 100 |
| | 500 | 99.8 | 84 | 77 |
| Sample 4 | 10 | 99.9 | 92 | 100 |
| | 500 | 99.8 | 86 | 79 |
| Sample C1 | 10 | 99.8 | 93 | 98 |
| | 500 | 99.2 | 83 | 35 |

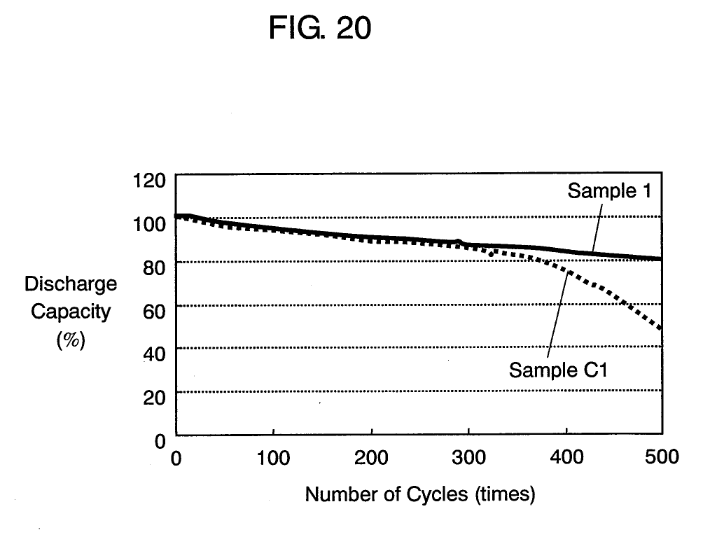

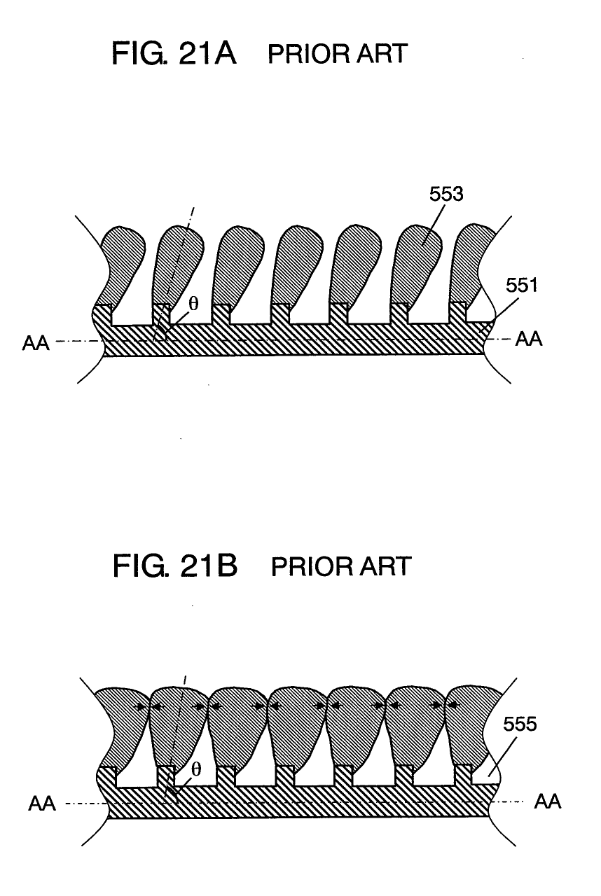

Also, as an example of charge/discharge cycle characteristic, the evaluation results of sample 1 and sample C1 are shown in FIG. 20.

As shown in Table 1, Table 2, and FIG. 20, there is no difference in capacity sustaining ratio between sample 1 and sample C1 at 10th cycle or so in the beginning of the cycle. However, at 500th cycle, the capacity sustaining ratio of sample 1 is about 80%, while the capacity sustaining ratio of sample C1 is lowered to about 35%. This is because the layer being less in expansion and contraction inside the column member serves to suppress the expansion and contraction of the column member. As a result, it is probably because the stress on the interface between the column member and current collector is reduced during the charge and discharge, causing the column member to become hard to peel off from the current collector in the cycle evaluation. Accordingly, it has been confirmed that a negative electrode provided with a layer being less in expansion and contraction in the column member is effective for the improvement of cycle characteristics.

Also, as shown in Table 1 and Table 2, in sample 1 to sample 4, it has been found that even in case the position of the layer being less in expansion and contraction is changed in the configuration of the column member, there is almost no difference in capacity sustaining ratio, charge/discharge efficiency, and high rate ratio, maintaining excellent cycle characteristic.

From the above description, it has been confirmed that a negative electrode having a structure provided with at least one layer being less in expansion and contraction inside and outside the column member is effective for the improvement of the high rate characteristic and cycle characteristic.

### Second Exemplary Embodiment

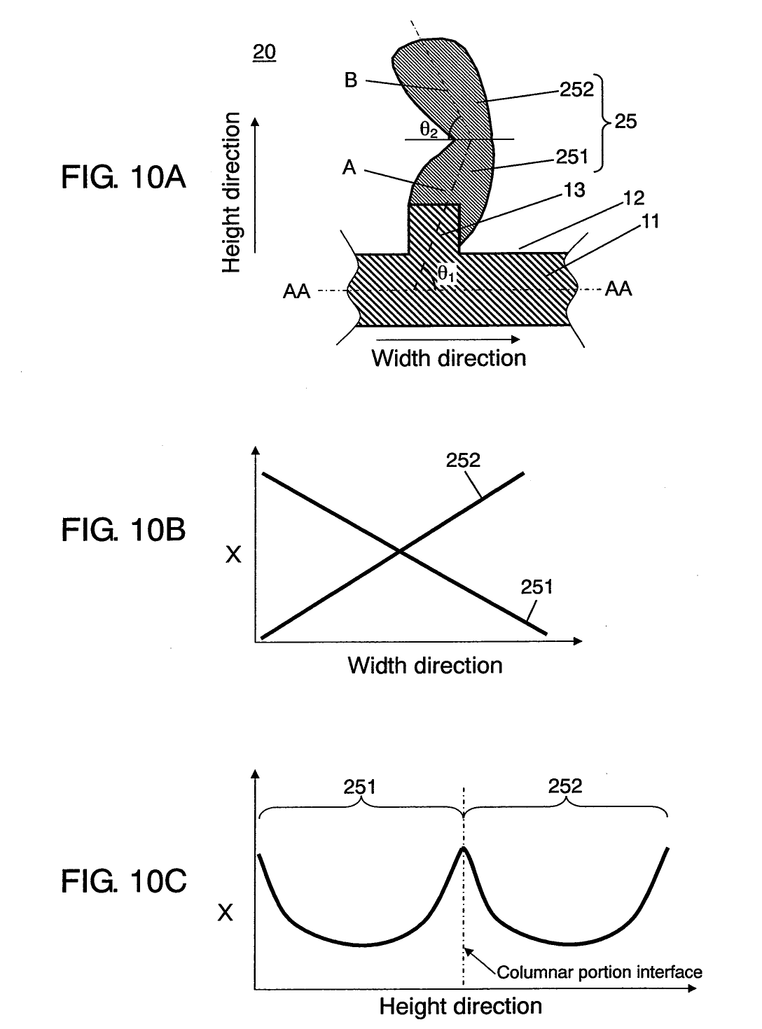

The structure of a negative electrode in the second exemplary embodiment of the present invention will be described in the following by using FIG. 10A to FIG. 10C.

FIG. 10A is a partially sectional schematic view showing the structure of the negative electrode in the second exemplary embodiment of the present invention. FIG. 10B is a schematic view for describing the change in value x in the width direction of active material of each columnar portion in the second exemplary embodiment of the present invention. FIG. 10C is a schematic view for describing the change in value x in the height direction of active material of each columnar portion in the second exemplary embodiment of the present invention. In this exemplary embodiment, a laminate type battery the same as shown in FIG. 1 is used, and the detailed description is omitted. Also, the component materials for the positive electrode mixture layer, positive electrode current collector, current collector, and columnar portion are same as in the first exemplary embodiment, and the detailed description is omitted. Also, an example of active material represented by SiOx (0≦x≦2.0) including silicon at least is described in the following, but the present invention is not limited to this. Also, the width direction represents the oblique direction of the columnar portion and specially longitudinal (winding) direction of electrode group in the cylindrical battery. So hereinafter inclusive of longitudinal (winding) direction referred to as width direction.

As shown in FIG. 10A, for example, at least the upper surface of current collector 11 formed from conductive metal material such as copper (Cu) foil is provided with concave 12 and convex 13. And, on the upper surface of convex 13 is obliquely formed active material represented by SiOx that configures negative electrode 20 in the form of column member 25 formed of n (n≧2) stages of columnar portions, for example, by an evaporation method using a sputtering method or vacuum evaporation method.

The example of column member 25 formed with n=2 stages of first columnar portion 251 and second columnar portion 252 in a laminated fashion is specifically described in the following, but the present invention is not limited to this provided that the number of stages is n≧2.

First, first columnar portion 251 of column member 25 is formed so that oblique angle θ₁ is formed by center line (A) in the oblique direction of first columnar portion 251 and center line (AA-AA) in the thickness direction of current collector 11 at least on convex 13 of current collector 11. And, second columnar portion 252 of column member 25 is formed on first columnar portion 251 so that oblique angle θ₂ is formed by center line (B) in the oblique direction thereof and center line (AA-AA) in the thickness direction of current collector 11. In this case, first columnar portion 251 and second columnar portion 252 of column member 25 are disposed, as schematically shown in FIG. 10B, so that the element containing ratio in the width direction, for example, the changing direction of value x is different between first columnar portion 251 and second columnar portion 252 for example formed from SiOx. That is, the value of x is gradually increased from the oblique angle side forming an acute angle of first columnar portion 251 and second columnar portion 252 toward the obtuse angle side. Shown in FIG. 10B is the value of x that changes linearly, but the present invention is not limited to this.

Further, as shown in FIG. 10C, first columnar portion 251 is formed with a layer (not shown) being less in expansion and contraction due to insertion and extraction of lithium ion, of which the value of x near convex 13 of current collector 11 and near the end is larger than the value of x in the middle of first columnar portion and higher in oxygen atom containing ratio. Similarly, second columnar portion 252 is formed with a layer (not shown) being less in expansion and contraction due to insertion and extraction of lithium ion, of which the value of x near an area bonded to first columnar portion 251 and near the end is larger than the value of x in the middle of second columnar portion 252 and higher in oxygen atom containing ratio.

Here, the heights of first columnar portion 251 and second columnar portion 252 are optional provided that they satisfy the requirement for the design capacity of the battery and do not come in contact with an adjacent column member. Similarly, oblique angles θ₁, θ₂ are preferable to be either of same and different angles provided that they do not come in contact with adjacent column member 25 due to expansion and contraction during insertion and extraction of lithium ion.

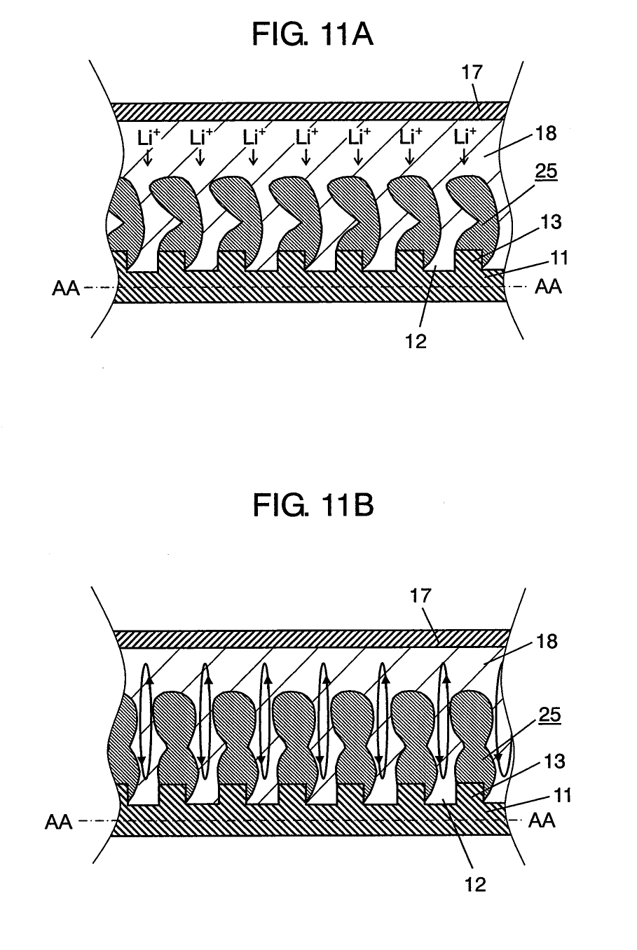

The operation in charge and discharge of a secondary battery configured by the negative electrode for nonaqueous electrolyte secondary battery of the present exemplary embodiment will be described in the following by using FIG. 11A and FIG. 11B.

FIG. 11A is a partially sectional schematic view showing the before-charge condition of the nonaqueous electrolyte secondary battery in the second exemplary embodiment of the present invention. FIG. 11B is a partially sectional schematic view showing the after-charge condition of the nonaqueous electrolyte secondary battery in the second exemplary embodiment of the present invention.

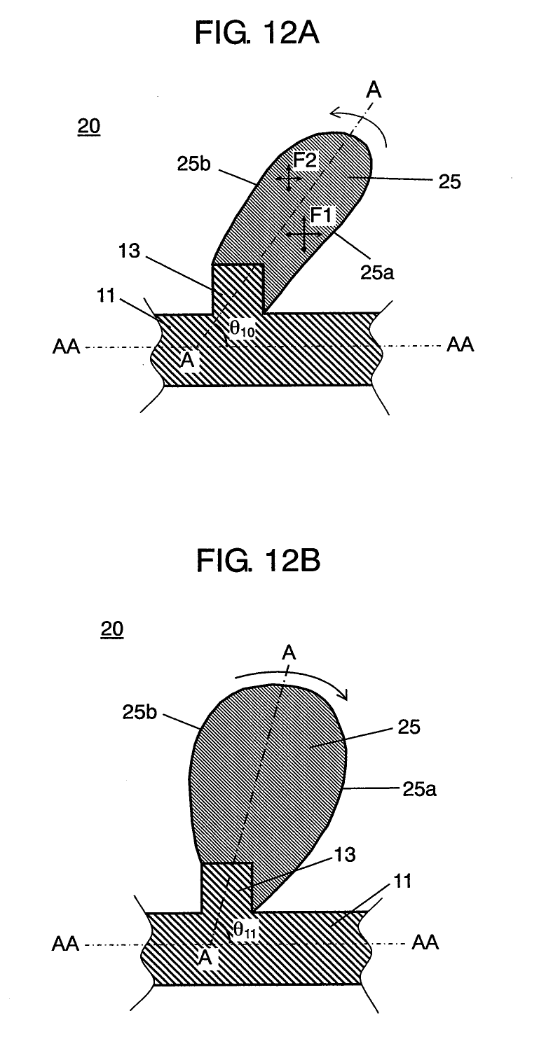

Column member 25 obliquely formed with two stages of columnar portions on convex 13 of current collector 11 expands in volume due to insertion of lithium ion in charging of nonaqueous electrolyte secondary battery. In this case, along with expansion in volume, as described in detail by using FIG. 12A and FIG. 12B in the following, first columnar portion 251 and second columnar portion 252 of column member 25 become greater in oblique angles θ₁, θ₂, and consequently, column member 25 changes in shape rising upright for example as shown in FIG. 11B. Contrarily, in discharge mode, it contracts in volume due to extraction of lithium ion as shown in FIG. 11A, and at the same time, it is reduced in oblique angles θ₁, θ₂, returning to the initial state of column member 25. In this case, although it is exaggerated in FIG. 11B, the layer being less in expansion and contraction and larger in the value of x of column member 25 is less in the amount of expansion due to insertion of lithium ion. On the other hand, in the middle being smaller in the value of x of first columnar portion 251 and second columnar portion 252, column member 25 is shaped with the negative electrode active material greatly expanded.

Here, as shown in FIG. 11A, in the initial state of charge, column member 25 formed of two stages of first columnar portion 251 and second columnar portion 252 is obliquely formed on convex 13 of current collector 11, and therefore, when column member 25 is viewed in projection from positive electrode 17, concave 12 of current collector 11 is partially shielded by column member 25 with respect to positive electrode 17. Accordingly, lithium ion discharged from positive electrode 17 in charging is prevented from directly arriving the concave 12 of current collector 11 by column member 25 of the negative electrode, causing most of it to be inserted by column member 25, and thereby, the deposition of lithium metal is suppressed. And, with insertion of lithium ion, the oblique angle of first columnar portion 251 and second columnar portion 252 becomes larger, and finally, the state of column member 25 becomes nearly perpendicular to current collector 11. It is not always required to be perpendicular, and it is allowable to be zigzag with the oblique angle less than 90 deg. in accordance with the design factors such as the stage numbers of columnar portions and the oblique angles, but it is desirable to be designed to 90 deg. in oblique angle.

Further, as shown in FIG. 11B, when a battery fully charged is discharged, the state of column member 25 formed of columnar portions expanded due to the charge becomes perpendicular to current collector 11. As a result, electrolyte solution 18 of nonaqueous electrolyte between adjacent column members 25 may easily move between column members 25 as shown by the arrow mark in the figure. Also, since electrolyte solution 18 between column members 25 may easily circulate convectively through spaces between column members 25, the movement of lithium ion for example is not prevented. Further, since column member 25 is rising upright, the moving distance of lithium ion in electrolyte solution 18 is shorter as compared with its early status in charging when it rises obliquely. In this way, lithium ion may linearly move. As a result, it is possible to greatly improve the discharge characteristic in high rate discharge and at low temperatures.

Also, generally, in the case of film depositing by a sputtering method or vacuum evaporation method, when the film is let to grow intermittently, the interface thereof is contaminated intermittently, often causing non-continuous portions to be formed on the connection interface. Consequently, for example, peeling is liable to take place when stresses are applied to the connection interface. However, according to the present exemplary embodiment, even in case a non-continuous portion is formed on the connection interface, almost no stress is generated due to expansion and contraction because the non-continuous portion is provided with a layer being less in expansion and contraction caused by insertion and extraction of lithium ion, and thereby, it is also possible to obtain such an excellent effect that a highly reliable column member having n stages can be formed.

The mechanism of change in oblique angle of column member 25 in a reversible fashion due to insertion and extraction of lithium ion will be described in the following by using FIG. 12A and FIG. 12B.

In the present invention, the column member is formed of n (n≧2) stages of columnar portions, but for making the description easier, in FIG. 12A and FIG. 12B, the column member described is formed of one columnar portion at least disposed on a convex of a current collector. Also, it is of course possible to obtain a similar mechanism and function with n-stage configuration.

FIG. 12A is a partially sectional schematic view showing the before-charge condition of the column member of negative electrode 20 in the second exemplary embodiment of the present invention. FIG. 12B is a partially sectional schematic view showing the after-charge condition of the column member of negative electrode 20 in the second exemplary embodiment of the present invention.

In column member 25 shown in FIG. 12A and FIG. 12B, the element containing ratio (value x) of active material SiOx is changed so that the value of x becomes continuously larger from the lower side 25a where an acute angle is formed by the center line (A-A) of column member 25 and the center line (AA-AA) of current collector 11 toward the upper side 25b where an obtuse angle of column member 25 is formed. Similarly, portions near the interface and at the tip of convex 13 of current collector 11 of column member 25 are changed so that the element containing ratio of active material SiOx becomes greater as compared with the middle portion thereof, thereby providing a layer being less in expansion and contraction. Generally, as described above, active material SiOx becomes less in the amount of expansion due to insertion of lithium ion with increase of value x from 0 to 2.

That is, as shown in FIG. 12A, the expansion stress generated due to expansion caused by insertion of lithium ion in charging is continuously reduced from expansion stress F1 at lower side 25a of column member 25 to expansion stress F2 at upper side 25b. As a result, oblique angle θ formed by center line (A-A) of column member 25 and center line (AA-AA) of current collector 11 changes from θ₁₀ to θ₁₁, and then column member 25 rises upright in the arrow-marked direction of FIG. 12A. Contrarily, in discharging, the expansion stress is reduced due to contraction caused by extraction of lithium ion. As a result, oblique angle θ of column member 25 changes from θ₁₁ to θ₁₀, and then column member 25 changes in shape in the arrow-marked direction of FIG. 12B.

As described above, column member 25 changes in oblique angle in a reversible fashion due to insertion and extraction of lithium ion.

In this case, the layer being less in expansion and contraction which is disposed near the interface and at the tip of convex 13 of current collector 11 of column member 25 is larger in value x, and hard to contribute to expansion and contraction, and therefore, only the middle portion is expanded and contracted. That is, since there is no generation of stresses due to expansion and contraction of column member 25 in the vicinity of convex 13 of current collector 11, the bonding (connection) strength is hard to become lowered.

As described above, by enhancing the element containing ratio (value x) of portions near the interface and at the tip of the convex of the current collector in the height direction of the column member of SiOx, it is possible to manufacture a column member formed of n stages having a layer being less in expansion and contraction. Consequently, even in case expansion and contraction of the column member are repeated during the charge/discharge cycle, there is no generation of great stresses on the bonding interface of the convex of current collector and the column member, and it is possible to realize a hard-to-peel and highly reliable negative electrode.

Also, since at least two stages of columnar portions are laminated to form the column member, even when the amount of active material capable of inserting and extracting lithium ion is equalized, the height (thickness) of columnar portion at each stage can be decreased. As a result, as compared with the case of configuring one column member, the amount of expansion of the columnar portion at each stage becomes less. Further, since the amount of expansion at the tip of columnar portion is less, the interval between adjacent column members is hard to become narrower, and it hardly causes the column members to push against each other. Accordingly, the allowable amount for expansion of the column member can be greatly increased, enabling the increase in density of column members which can be formed in a current collector and the insertion and extraction of more lithium ion, and thereby, it becomes possible to enhance the battery capacity.

Also, due to the column member formed of n stages of columnar portions, a large space can be maintained between adjacent column members even when the column members are expanded. And, since adjacent column members are hard to come into contact with each other, it is possible to prevent the generation of stresses due to contacting and to prevent resultant creasing of the current collector and peeling off from the current collector. As a result, it is possible to realize a nonaqueous electrolyte secondary battery which is excellent in charge/discharge cycle characteristics.

According to the present exemplary embodiment, a high capacity sustaining ratio can be realized in the charge/discharge cycle while making it possible to enhance the capacity, and it is possible to manufacture a nonaqueous electrolyte secondary battery which is hard-to-peel and excellent in reliability.

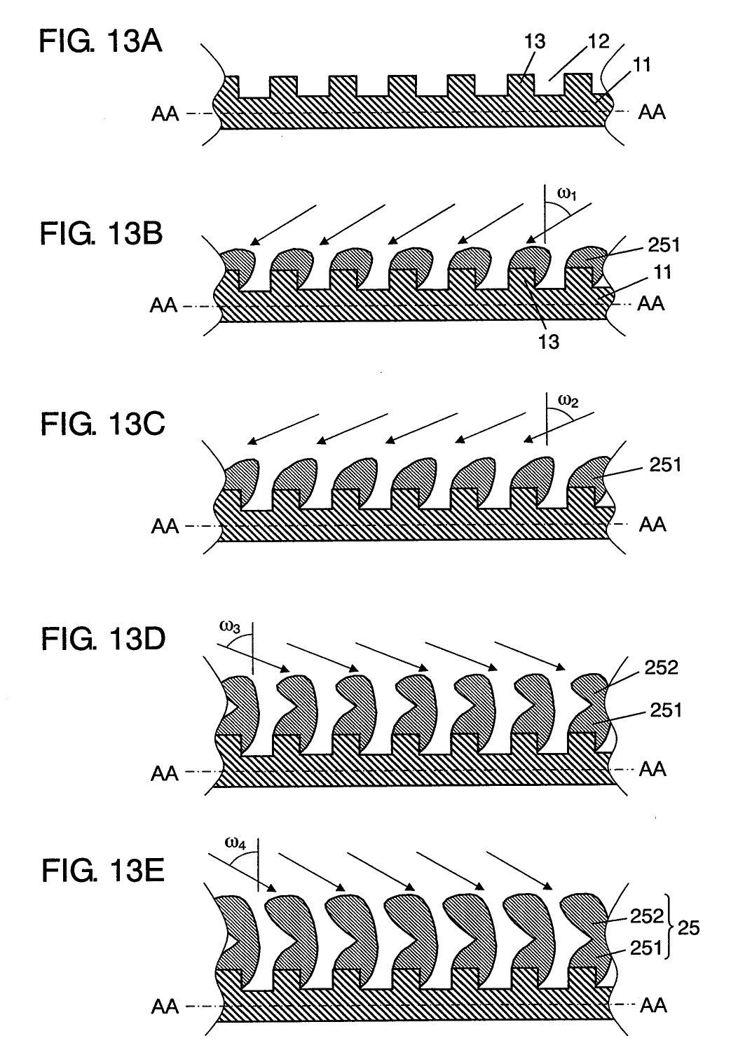

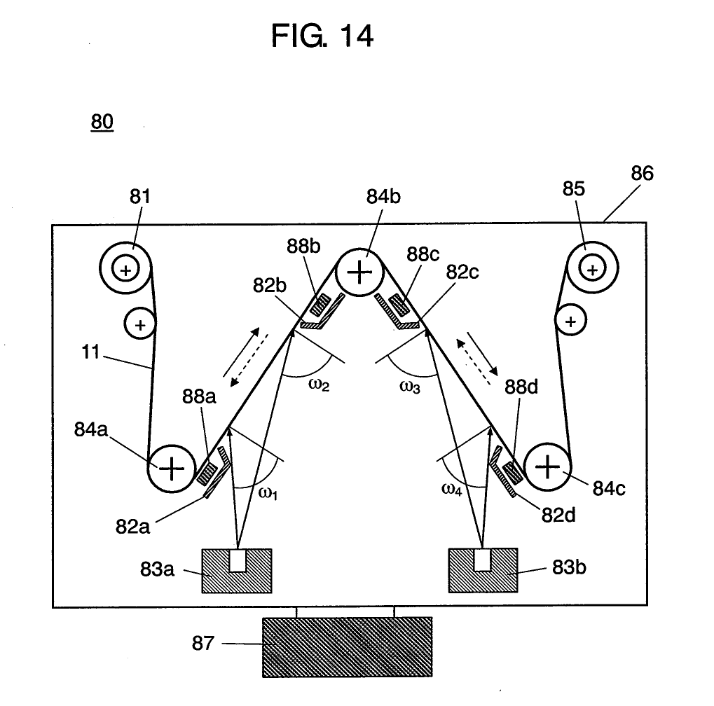

The method of manufacturing a column member of a negative electrode for nonaqueous electrolyte secondary battery in the exemplary embodiment of the present invention will be described in detail in the following with reference to FIG. 13A to FIG. 13E, and FIG. 14.

FIG. 13A to FIG. 13E are partially sectional schematic views for describing the method of manufacturing a column member formed of n stages of columnar portions of a negative electrode for nonaqueous electrolyte secondary battery in the second exemplary embodiment of the present invention. FIG. 14 is a schematic view for describing its manufacturing apparatus. A column member formed of n=2 stages is described as an example in the following.

Here, manufacturing apparatus 80 for forming a column member shown in FIG. 14 is configured in that vacuum chamber 86 includes delivery roll 81, film depositing roll 84a, 84b, 84c, take-up roll 85, evaporation source 83a, 83b, mask 82a, 82b, 82c, 82d, and oxygen intake nozzle 88a, 88b, 88c, 88d, and the pressure is reduced by vacuum pump 87. And, while current collector 11 moves in the arrow-marked direction shown by a solid line in the figure between masks 82a, 82b between film depositing rolls 84a, 84b, a first columnar portion is formed. Further, while current collector 11 moves in the arrow-marked direction shown by a solid line in the figure between masks 82c, 82d between film depositing rolls 84b, 84c, a second columnar portion is formed on the first columnar portion. In this case, current collector 11, between film depositing rolls 84a, 84b, moves in the direction of going away from the evaporation source, and between film depositing rolls 84b, 84c, moves in the direction of coming closer to the evaporation source, while maintaining the specified angle of inclination. That is, in the vicinity of mask 82a, evaporating particles enter the current collector from evaporation source 83a at incident angle ω₁ to the normal line of current collector 11, and in the vicinity of mask 82b, evaporating particles enter the current collector at incident angle ω₂. Accordingly, with the movement of current collector 11, the first columnar portion is formed while the incident angle of evaporating particles changes from ω₁ to ω₂. Also, the second columnar portion is similarly formed in such manner that evaporating particles enter the current collector from evaporation source 83b at incident angle ω₃ to the normal line of current collector 11, and with the movement of current collector 11, the incident angle of evaporating particles changes from ω₃ to ω₄.

Also, oxygen intake nozzles 88a, 88b, 88c, 88d supply oxygen to the film forming region of the active material in the vicinity of masks 82a, 82b, 82c, 82d respectively.

This manufacturing apparatus is an example of apparatus for manufacturing a column member by forming n stages of columnar portions on one surface of a current collector. Actually, however, it is common to have a configuration for manufacturing a column member on both surface of a current collector.

The status of each columnar portion will be specifically described in the following.

Firstly, as shown in FIG. 13A and FIG. 14, with use of strip-shaped electrolytic copper foil of 30 μm thick, concave 12 and convex 13 are formed by a plating method on the surface thereof, and current collector 11 with convex 13 formed for example by 7.5 μm in height, 10 μm in width, and 20 μm in interval is fabricated (1st step). And, current collector 11 is disposed between delivery roll 81 and take-up roll 85 shown in FIG. 14.

Subsequently, as shown in FIG. 13B and FIG. 14, current collector 11 is moved between film depositing rolls 84a, 84b in the direction of going away from evaporation source 83a while maintaining the specified angle of inclination. In this case, an active material such as Si (silicon: purity 99.999%) is heated and evaporated by means of electron beam in the oxygen atmosphere of pressure 3.5 Pa for example inside the vacuum chamber 86. In this way, evaporating particles enter into the area on convex 13 of current collector 11 from the arrow-marked direction in FIG. 13B.

And, first in the vicinity of mask 82a in an early stage of film forming, with the component of evaporating particle entering at incident angle ω₁ to the normal line of current collector 11 and the oxygen supplied from oxygen intake nozzle 88a near mask 82a, active material SiOx having a composition similar to SiO₂ being larger in value x is formed as a layer being less in expansion and contraction on the interface against convex 13 of current collector 11.

After that, with the movement of current collector 11 from film depositing roll 84a to film depositing roll 84b, first columnar portion 251 grows with evaporating particles while the incident angle changes from ω₁ to ω₂. In this case, in the film forming region where evaporating particle is not shielded by masks 82a, 82b, the number of evaporating particles and the amount of oxygen supplied from oxygen intake nozzles 88a, 88b change according to the distance from evaporation source 83a. That is, when the distance from evaporation source 83a is short, SiOx being smaller in the value of x is formed, and with increase in the distance, SiOx being larger in the value of x is formed. In this way, first columnar portion 251 grows in a state such that the value of x sequentially changes in the direction of width. For example, in FIG. 13B, the value of x becomes smaller at the right-hand side of the figure, and the value of x becomes larger at the left-hand side of the figure.

And, as shown in FIG. 13C and FIG. 14, in the vicinity of mask 82b where the evaporating particle enters at incident angle ω₂, with oxygen supplied from oxygen intake nozzle 88b, first columnar portion 251 film-formed with SiOx having a composition similar to SiO₂ being larger in the value of x as a layer being less in expansion and contraction is formed at the tip portion (2nd step). Particularly, with evaporating particles coming therein when current collector 11 moves under mask 82b, a composition similar to SiO₂ being larger in the value of x is efficiently formed near the tip portion. In this way, first columnar portion 251 of 15 μm thick in the oblique direction is formed at angle θ₁ on convex 13 of current collector 11 at least.

Next, as shown in FIG. 13D and FIG. 14, between film depositing roll 84c and film depositing roll 84b disposed in a position symmetrical to film depositing roll 84a, current collector 11 with the first columnar portion formed thereon is moved while maintaining the specified oblique angle in the direction of coming closer to evaporation source 83b. In this case, an active material such as Si (silicon: purity 99.999%) from evaporation source 83b is heated and evaporated by an electron beam, and the evaporating particle is applied to the tip portion of first columnar portion 251 at incident angle ω₃ in the arrow-marked direction in FIG. 13D.

In that case, the same as in FIG. 13B, in the vicinity of mask 82c, with the component of evaporating particle entering at incident angle ω₃ to the normal line of current collector 11 and the oxygen supplied from oxygen intake nozzle 88c near mask 82c, active material SiOx having a composition similar to SiO₂ being larger in value x is formed as a layer being less in expansion and contraction on the interface against the tip portion of first columnar portion 251 formed on current collector 11.

After that, with the movement of current collector 11 from film depositing roll 84b to film depositing roll 84c, second columnar portion 252 grows with evaporating particles while the incident angle changes from ω₃ to ω₄. In this case, in the film forming region where evaporating particle is not shielded by masks 82c, 82d, the number of evaporating particles and the amount of oxygen supplied from oxygen intake nozzles 88c, 88d change according to the distance from evaporation source 83b. That is, when the distance from evaporation source 83b is short, SiOx being smaller in the value of x is formed, and as the distance becomes longer, SiOx being larger in the value of x is formed. In this way, second columnar portion 252 grows in a state such that the value of x sequentially changes in the direction of width. For example, in FIG. 13D, the value of x becomes smaller at the left-hand side of the figure, and the value of x becomes larger at the right-hand side of the figure.

And, as shown in FIG. 13E and FIG. 14, in the vicinity of mask 82d where the evaporating particle enters at incident angle ω₄, with oxygen supplied from oxygen intake nozzle 88d, second columnar portion 252 formed with SiOx having a composition similar to SiO₂ being larger in the value of x as a layer being less in expansion and contraction is formed at the tip portion (3rd step). Particularly, with evaporating particles coming therein when current collector 11 moves under mask 82d, a composition similar to SiO₂ being larger in the value of x is efficiently formed near the tip portion. In this way, second columnar portion 252 of 15 μm thick in the oblique direction is formed at angle θ₂ on first columnar portion 251.

Through the above steps, first columnar portion 251 and second columnar portion 252 are formed as column member 25 having a layer being less in expansion and contraction and larger in the value of x at both ends in the height direction than the value in the middle. Simultaneously, negative electrode 20 is fabricated having column member 25 of which first columnar portion 251 and second columnar portion 252 are opposite to each other with respect to the width direction of current collector 11 and the changing direction of value x, and also different from each other with respect to the oblique angle and the oblique direction.

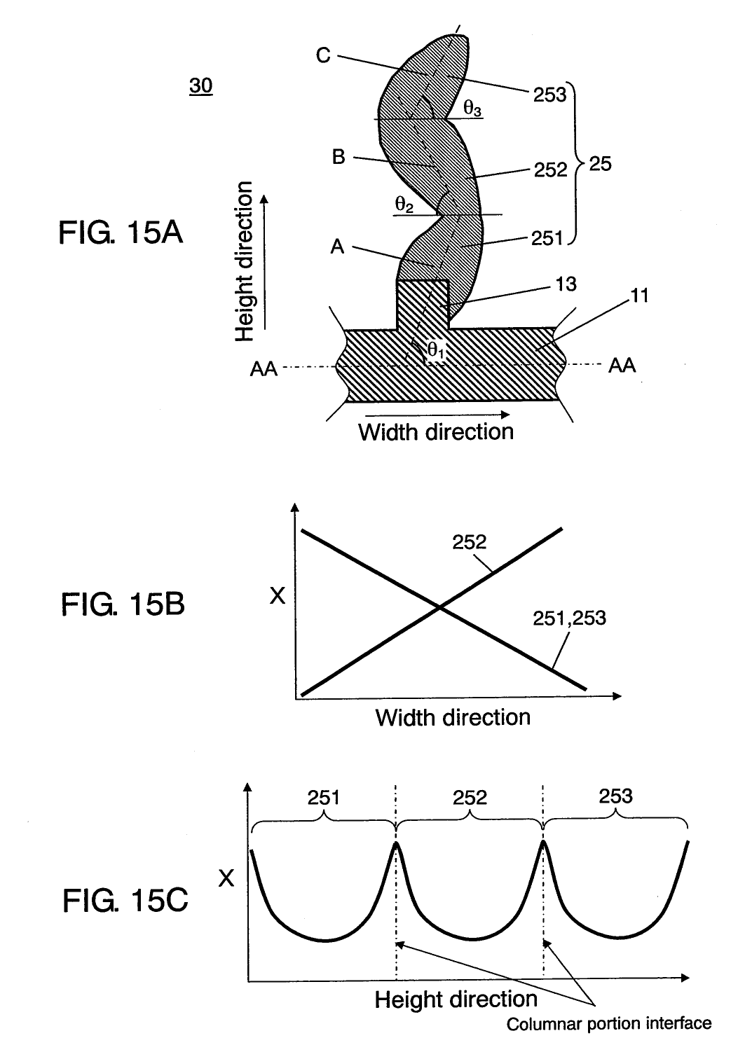

In the present exemplary embodiment, a column member formed of optional n=2 stages of columnar portions has been described as an example, but the present invention is not limited to this. For example, a column member formed of optional n (n≧2) stages of columnar portions can be formed by repeating the 2nd step of FIG. 13B and the 3rd step of FIG. 13E. For example, as shown in FIG. 15A to FIG. 15C, in the case of n=3 stages, third columnar portion 253 is desirable to be same in the oblique direction and the changing direction of value x of SiOx as first columnar portion 251. Also, oblique angle θ₃ is preferable to be either of being same as and different from oblique angle θ₁. Here, oblique angle θ₃ is an angle formed by the center line (C) in the oblique direction thereof and the center line (AA-AA) in the thickness direction of current collector 11.

In this case, as the manufacturing apparatus 80, it is desirable to be configured in that the film depositing rolls and evaporation source are disposed in a series fashion in order to fabricate a column member of n stages while moving the current collector in one direction. Further, it is preferable to form a column member on one surface of a current collector, followed by forming a column member on the other surface of the current collector by reversing the current collector. In this way, it is possible to manufacture a negative electrode with excellent productivity.

Also, in this preferred embodiment, an example of manufacturing apparatus 80 provided with a plurality of evaporation sources has been described, but the present invention is not limited to this. For example, in the case of n=2 stages, it is also preferable to dispose one evaporation source in a position opposing to film depositing roll 84b. In this way, it is possible to simplify the configuration of the apparatus.

The present invention will be specifically described in the following by using embodied examples.

### EMBODIED EXAMPLE 1

First of all, a column member of a negative electrode was manufactured by using a manufacturing apparatus shown in FIG. 14.

First, used as a current collector is strip-shaped electrolytic copper foil of 30 μm thick with a convex formed on the surface thereof by a plating method by 7.5 μm in width, 10 μm in height, and 20 μm in interval.

And, Si is used as an active material for the negative electrode, and with use of an evaporation unit (the evaporation source, crucible, and electron beam generator are included in one unit), the first columnar portion formed from SiOx was fabricated by introducing oxygen gas of 99.7% in purity from an oxygen intake nozzle into a vacuum chamber and changing the value of x in the width direction. In this case, the inside of the vacuum chamber is in an oxygen atmosphere of pressure 3.5 Pa. Also, during the evaporation, the electron beam generated by an electron beam generator was deflected by using a deflection yoke and applied to the evaporation source. Scrap material (scrap silicon: purity 99.999%) generated in forming a semiconductor wafer was used as an evaporation source.

Also, the first columnar portion was formed at a film deposition speed of about 8 nm/s, adjusting the specified oblique angle for the movement of the current collector so that the average angle of angles ω₁, ω₂ becomes 60 deg. In this way, the first columnar portion at the first stage (for example, 15 μm in height, and 150 μm² in sectional area) was formed. Similarly, by using the forming method described in the second exemplary embodiment, the second columnar portion at the second stage (for example, 15 μm in height and 150 μm² in sectional area) was formed, thereby forming a column member having two stages.

The angle to the center line of the current collector of the column member in the negative electrode evaluated through sectional observation by means of a scanning electronic microscope (Hitachi S-4700) is such that oblique angle θ of columnar portion at each stage was on the average about 41 deg. In this case, the thickness (height) of the column member then formed was 30 μm in the normal direction.

Also, the result of investigation of oxygen distribution by measuring the line distribution in the sectional direction of columnar portion at each stage configuring the column member of the negative electrode with the use of EPMA is that the oxygen concentration (value x) was continuously increased in the direction (180-θ) from the oblique angle θ side in the width direction of the first columnar portion and the second columnar portion. And, the increasing directions of oxygen concentration (value x) in the first columnar portion and second columnar portion were opposite to each other. In this case, the range of x was 0.1 to 2, and on the average 0.6.

Also, similarly formed is a layer being less in expansion and contraction wherein the oxygen concentration (value x) near both ends of each columnar portion is different from the oxygen concentration (value x) in the middle in the height direction of the column member. And, in this case, the range of oxygen concentration (value x) near both ends of the columnar portion was 1.5 to 2, and the range of oxygen concentration (value x) in the middle was 0.1 to 1.5.

As described above, a negative electrode was manufactured, comprising a column member having a layer being less in expansion and contraction, which is different in oxygen element containing ratio between the both ends and the middle portion in the height direction of each columnar portion at least.

After that, Li metal of 15 μm was evaporated on the negative electrode surfaces by a vacuum evaporation method. Further, at the inner periphery side of the negative electrode, Cu foil not confronting the positive electrode was provided with an exposed portion, and a negative electrode lead made of Cu was welded thereto.

Subsequently, a positive electrode having a positive electrode active material capable of inserting and extracting lithium ion was manufactured by the same method as for the embodied example 1 in the first exemplary embodiment.

By using the negative electrode manufactured as described above, a laminate type battery of 21 mAh in design capacity was manufactured by the same method as for the embodied example 1 in the first exemplary embodiment. This battery is sample 1.

### EMBODIED EXAMPLE 2

A negative electrode was manufactured the same as in the embodied example 1 except that the column member formed has n=4 stages of columnar portions each of which is about 7.5 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage and third stage and the columnar portions at the second stage and fourth stage. In this case, the range of x is 0.1 to 2, and on the average 0.6.

Except the use of the above negative electrode, the nonaqueous electrolyte secondary battery manufactured by the same method as for the embodied example 1 is sample 2.

### EMBODIED EXAMPLE 3

A negative electrode was manufactured by the same method as for the embodied example 1 except that the column member formed has n=6 stages of columnar portions each of which is about 5 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.6.

Except the use of the above negative electrode, the nonaqueous electrolyte secondary battery manufactured by the same method as for the embodied example 1 is sample 3.

### EMBODIED EXAMPLE 4

A negative electrode was manufactured by the same method as for the embodied example 1 except that the column member formed has n=10 stages of columnar portions each of which is about 3 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, fifth stage, seventh stage, and ninth stage and the columnar portions at the second stage, fourth stage, sixth stage, eighth stage, and tenth stage. In this case, the range of x is 0.1 to 2, and on the average 0.6.

Except the use of the above negative electrode, the nonaqueous electrolyte secondary battery manufactured by the same method as for the embodied example 1 is sample 4.

### EMBODIED EXAMPLE 5

A negative electrode was manufactured by the same method as for the embodied example 3 except that the column member is formed, adjusting the moving angle of current collector so that the average angle of angles ω₁, ω₂ is 5 deg., and the average angle of ω₃, ω₄ is 130 deg.

The oblique angle of each columnar portion is on the average 31 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.6.

Except the use of the above negative electrode, the nonaqueous electrolyte secondary battery manufactured by the same method as for the embodied example 1 is sample 5.

### EMBODIED EXAMPLE 6

A negative electrode was manufactured by the same method as for the embodied example 3 except that the internal pressure of the vacuum chamber is 1.7 Pa in oxygen atmosphere, and the thickness of each columnar portion is 4 μm.

The oblique angle of each columnar portion is on the average 41 deg., and the thickness (height) of the column member formed is 24 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.3.

After that, Li metal of 10 μm was evaporated on the negative electrode surfaces by a vacuum evaporation method.

Except the use of the above negative electrode, the nonaqueous electrolyte secondary battery manufactured by the same method as for the embodied example 1 is sample 6.

### COMPARATIVE EXAMPLE 1

A negative electrode was manufactured by the same method as for the embodied example 1 except that the column member is obliquely rising in one stage and 30 μm in height (thickness).

The angle to the center line of the current collector of the column member in the negative electrode evaluated through sectional observation by means of a scanning electronic microscope (Hitachi S-4700) is such that oblique angle of the column member is about 41 deg. In this case, the thickness (height) of the column member then formed is 30 μm.

Also, the result of investigation of oxygen distribution by measuring the line distribution in the sectional direction of columnar portion configuring the column member of the negative electrode with the use of EPMA is that the oxygen concentration (value x) was continuously increased in the direction (180-θ) from the oblique angle θ side in the width direction. The range of x is 0.1 to 2, and on the average 0.6.

Except the use of the above negative electrode, the nonaqueous electrolyte secondary battery manufactured by the same method as for the embodied example 1 is sample C1.

With respect to each nonaqueous electrolyte secondary battery manufactured as described above, the battery capacity was measured by the same method as for the second exemplary embodiment, and the charge/discharge cycle characteristic was evaluated.

The items and the evaluation results of sample 1 to sample 6 and sample C1 are shown in Table 3 and Table 4 in the following.

TABLE 3

| | Vacuum level | | Oblique | First columnar | | Average |
|---|---|---|---|---|---|---|
| | with O₂ | n | Angle | portion thickness | Column member | value of x |
| | introduced (Pa) | (stages) | (deg.) | (μm) | thickness (μm) | of SiOx |
| Sample 1 | 3.5 | 2 | 41 | 15 | 30 | 0.6 |
| Sample 2 | 3.5 | 4 | 41 | 7.5 | 30 | 0.6 |
| Sample 3 | 3.5 | 6 | 41 | 5 | 30 | 0.6 |
| Sample 4 | 3.5 | 10 | 41 | 3 | 30 | 0.6 |
| Sample 5 | 3.5 | 6 | 31 | 5 | 30 | 0.6 |
| Sample 6 | 1.7 | 6 | 41 | 4 | 24 | 0.3 |
| Sample C1 | 3.5 | 1 | 41 | 30 | 30 | 0.6 |

TABLE 4

| | Number of | Charge/ | | Capacity |
|---|---|---|---|---|
| | cycles | discharge | High rate | sustaining |
| | (times) | efficiency (%) | ratio (%) | ratio (%) |
| Sample 1 | 10 | 99.8 | 93 | 98 |
| | 500 | 99.8 | 86 | 78 |
| Sample 2 | 10 | 99.8 | 93 | 98 |
| | 500 | 99.8 | 87 | 79 |
| Sample 3 | 10 | 99.8 | 93 | 98 |
| | 500 | 99.8 | 87 | 82 |
| Sample 4 | 10 | 99.8 | 93 | 98 |
| | 500 | 99.8 | 88 | 82 |
| Sample 5 | 10 | 99.8 | 93 | 98 |
| | 500 | 99.8 | 87 | 79 |
| Sample 6 | 10 | 99.8 | 93 | 98 |
| | 500 | 99.8 | 88 | 80 |
| Sample C1 | 10 | 99.8 | 93 | 98 |
| | 500 | 99.2 | 83 | 48 |

As shown in Table 3 and Table 4, in the comparison of sample 1 and sample C1, there is no difference in capacity sustaining ratio in the 10th cycle or so in the initial stage. However, in the 500th cycle, the capacity sustaining ratio of sample 1 is about 80%, while the capacity sustaining ratio of sample C1 is as low as about 50%. This is probably because there is provided a layer being larger in value x and less in expansion and contraction, of which the active material on the connection interface is nearly equal in element ratio between columnar portions of the column member, and the layer serves to form an interface that is hard to peel during the charge and discharge.

Thus, it has been confirmed that providing the negative electrode with a column member having a layer being less in expansion and contraction on the connection interface between columnar portions on the convex of the current collector is effective to improve the cycle characteristic.

Also, as shown in Table 3 and Table 4, it has been found that, in sample 3 and sample 5, even with the oblique angle of each columnar portion of the column member changed from 41 deg. to 34 deg., there is almost no difference in capacity sustaining ratio, charge/discharge efficiency, and high rate ratio, and it is possible to obtain excellent characteristics.

Also, as shown in Table 3 and Table 4, it has been found that, in sample 1 to sample 4, even with the number of stages of columnar portions of the column member changed, there is almost no difference in capacity sustaining ratio, charge/discharge efficiency, and high rate ratio, and it is possible to obtain excellent characteristics.

Also, as shown in Table 3 and Table 4, it has been observed that, in sample 3 and sample 6, when the average value of x of SiOx of the column member is 0.3 and 0.6, sample 6 being smaller in the average value of x tends to become a little lower in capacity sustaining ratio after 500th cycle as compared with sample 3 being larger in the average value of x. This corresponds to the fact that to be smaller in the average value of x is to be greater in expansion and contraction during the charge and discharge. Accordingly, it can be considered that the stress and distortion between column members or current collector and columnar portion are increased due to expansion and contraction of the column member, giving rise to the tendency of becoming a little lowered in capacity sustaining ratio.

### Third Exemplary Embodiment

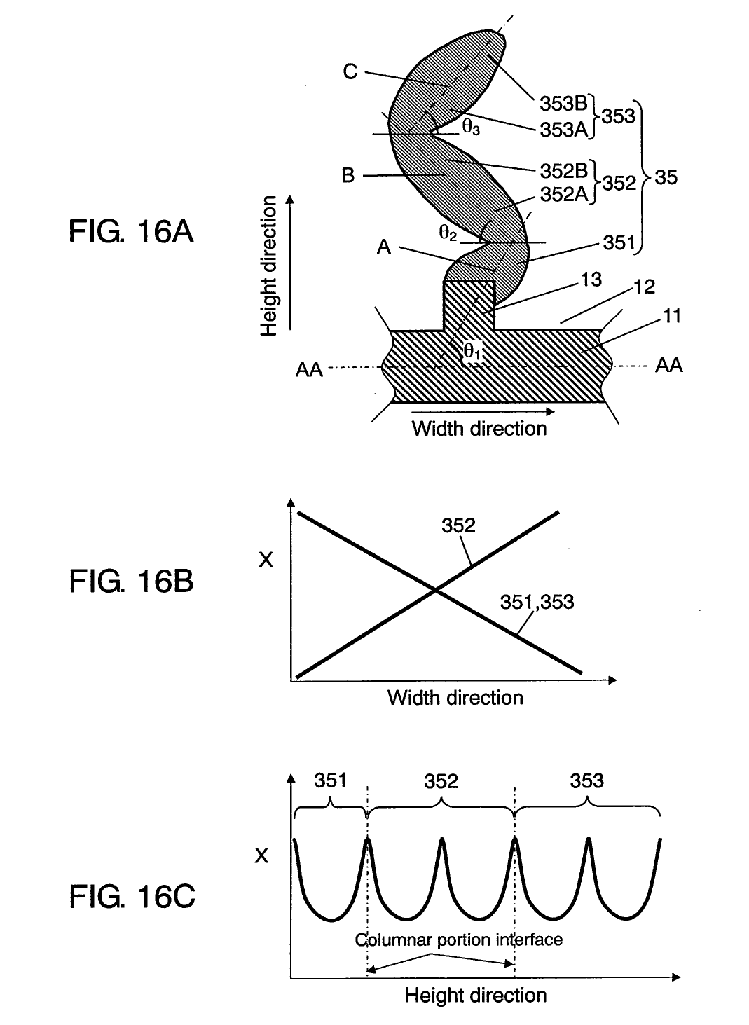

The structure of a negative electrode in the third exemplary embodiment of the present invention will be described in the following with reference to FIG. 16A to FIG. 16C.

FIG. 16A is a partially sectional schematic view showing the structure of the negative electrode in the third exemplary embodiment of the present invention. FIG. 16B is a schematic view for describing the change in value x in the width direction of active material of each columnar portion in the third exemplary embodiment of the present invention. FIG. 16C is a schematic view for describing the change in value x in the height direction of active material of each columnar portion in the third exemplary embodiment of the present invention. In this exemplary embodiment, a laminate type battery the same as shown in FIG. 1 is used, and the detailed description is omitted. Also, the component materials for the positive electrode mixture layer, positive electrode current collector, current collector, and columnar portion are same as in the first exemplary embodiment, and the detailed description is omitted. Also, an example of active material represented by SiOx (0≦x≦2.0) including silicon at least is described in the following, but the present invention is not limited to this.

As shown in FIG. 16A, for example, at least the upper surface of current collector 11 formed from conductive metal material such as copper (Cu) foil is provided with concave 12 and convex 13. And, on the upper surface of convex 13 is obliquely formed active material represented by SiOx that configures negative electrode 30 in the form of column member 35 formed of n (n≧2) stages of columnar portions, for example, by an oblique evaporation method using a sputtering method or vacuum evaporation method.

The example of column member 35 formed with n=3 stages of first columnar portion 351, second columnar portion 352, and third columnar portion 353 in a laminated fashion is specifically described in the following, but the present invention is not limited to this provided that the number of stages is n≧2.

First, first columnar portion 351 of column member 35 is formed so that oblique angle θ₁ is formed by center line (A) in the oblique direction of first columnar portion 351 and center line (AA-AA) in the thickness direction of current collector 11 at least on convex 13 of current collector 11. And, second columnar portion 352 of column member 35 is formed on first columnar portion 351 so that oblique angle θ₂ is formed by center line (B) in the oblique direction thereof and center line (AA-AA) in the thickness direction of current collector 11. Further, third columnar portion 353 of column member 35 is formed on second columnar portion 352 so that oblique angle θ₃ is formed by center line (C) in the oblique direction thereof and center line (AA-AA) in the thickness direction of current collector 11.

In this case, first columnar portion 351, second columnar portion 352, and third columnar portion 353 of column member 35 are disposed, as schematically shown in FIG. 16B, so that the element containing ratio in the width direction of each columnar portion formed from SiOx, for example, the changing directions of value x are different from each other. That is, the value of x is gradually increased from the oblique angle side forming an acute angle of first columnar portion 351, second columnar portion 352, and third columnar portion 353 toward the obtuse angle side. Shown in FIG. 16B is the value of x that changes linearly, but the present invention is not limited to this.

Further, as shown in FIG. 16C, first columnar portion 351 is formed with a layer (not shown) being less in expansion and contraction due to insertion and extraction of lithium ion, of which the value of x near convex 13 of current collector 11 and near the end is larger than the value of x of the middle portion of the first columnar portion and the oxygen atom containing ratio is higher. Similarly, second columnar portion 352 and third columnar portion 353 are formed with a layer (not shown) being less in expansion and contraction due to insertion and extraction of lithium ion, of which the value of x at both ends in the height direction and near the middle portion is larger than the value of x of other portions and the oxygen atom containing ratio is higher.

Here, the heights (thickness) of first columnar portion 351, second columnar portion 352, and third columnar portion 353 are optional provided that they satisfy the requirement for the design capacity of the battery and do not come in contact with an adjacent column member. Similarly, oblique angles θ₁, θ₂, θ₃ are preferable to be either of same and different angles provided that they do not come in contact with adjacent column member 35 due to expansion and contraction during insertion and extraction of lithium ion, and that the angle enables film forming.

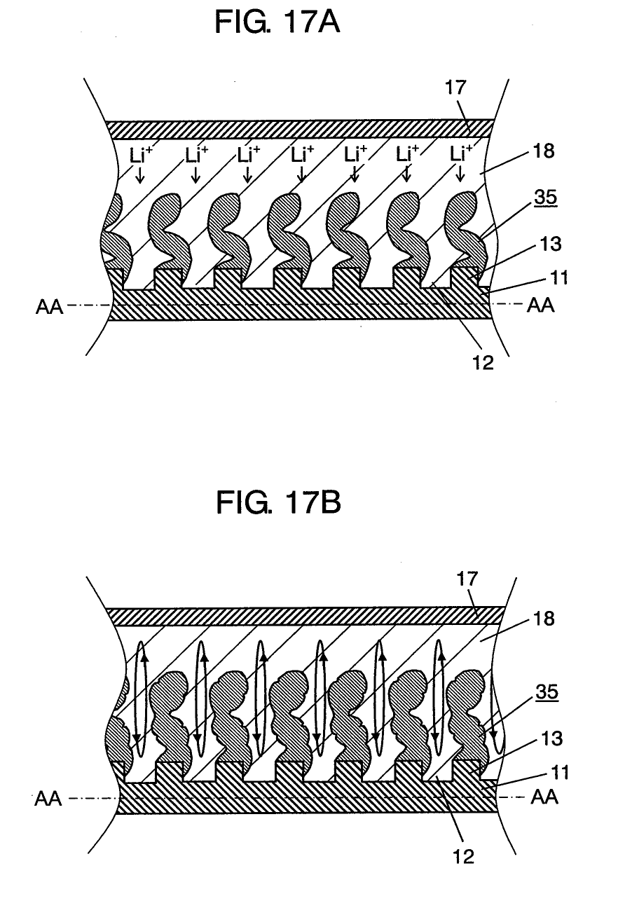

The operation in charge and discharge of a secondary battery configured by the negative electrode for nonaqueous electrolyte secondary battery of the present exemplary embodiment will be described in the following with reference to FIG. 17A and FIG. 17B.

FIG. 17A is a partially sectional schematic view showing the before-charge condition of the nonaqueous electrolyte secondary battery in the third exemplary embodiment of the present invention. FIG. 17B is a partially sectional schematic view showing the after-charge condition of the nonaqueous electrolyte secondary battery in the third exemplary embodiment of the present invention.

Column member 35 with three stages of columnar portions obliquely formed on convex 13 of current collector 11 expands in volume due to insertion of lithium ion in charging of the nonaqueous electrolyte secondary battery. In this case, along with expansion in volume, as described by using FIG. 12A and FIG. 12B in the second exemplary embodiment, first columnar portion 351, second columnar portion 352, and third columnar portion 353 of column member 35 become greater in oblique angles θ₁, θ₂, θ₃, and consequently, column member 35 changes in shape rising upright for example as shown in FIG. 17B. Contrarily, in discharge mode, it contracts in volume due to extraction of lithium ion as shown in FIG. 17A, and at the same time, it is reduced in oblique angles, θ₁, θ₂, θ₃, returning to the initial state of column member 35. In this case, although it is exaggerated in FIG. 17B, the layer being less in expansion and contraction and larger in the value of x of column member 35 is less in the amount of expansion due to insertion of lithium ion, and the active material is greatly expanded in shape at the middle portion of first columnar portion 351 and at both ends and portions other than near the middle portion of second columnar portion 352 and third columnar portion 353. That is, since the amount of expansion and contraction is less in the vicinity of middle portion of the second columnar portion and third columnar portion, the material is sometimes depressed in shape at the middle portion during the charge.

Here, it is not clearly shown in FIG. 17A, but actually in the initial state of charge, column member 35 formed of three stages of first columnar portion 351, second columnar portion 352, and third columnar portion 353 is obliquely formed on convex 13 of current collector 11, and therefore, when column member 35 is viewed in projection from positive electrode 17, concave 12 of current collector 11 is partially shielded by column member 35 with respect to positive electrode 17. Accordingly, lithium ion discharged from positive electrode 17 in charging is prevented from directly arriving the concave 12 of current collector 11 by column member 15 of the negative electrode, causing most of it to be inserted by column member 35, and thereby, the deposition of lithium metal is suppressed. And, with insertion of lithium ion, the oblique angles of first columnar portion 351, second columnar portion 352, and third columnar portion 353 become larger, and finally, the state of column member 35 becomes nearly perpendicular to current collector 11. It is not always required to be perpendicular, and it is allowable to be zigzag with the oblique angle less than 90 deg. in accordance with the design factors such as the stage numbers of columnar portions and the oblique angles, but it is desirable to be designed 90 deg. in oblique angle.

Further, as shown in FIG. 17B, the state of column member 35 formed of columnar portions expanded due to charging becomes perpendicular to current collector 11. As a result, electrolyte solution 18 between adjacent column members 35 may easily move between column members 35 as shown by the arrow mark in the figure. Also, since electrolyte solution 18 between column members 35 may easily circulate convectively through spaces between column members 35, the movement of lithium ion for example is not prevented. Further, since column member 35 is rising upright, the moving distance of lithium ion in electrolyte solution 18 is shorter as compared with the early stage of charging where it rises obliquely. In this way, lithium ion may linearly move. As a result, it is possible to greatly improve the discharge characteristic in high rate discharge and at low temperatures.

Also, generally, in the case of film forming by a sputtering method or vacuum evaporation method, if the film is let to grow intermittently, the interface thereof is contaminated intermittently, often causing non-continuous portions to be formed on the connection interface. Consequently, for example, peeling is liable to take place when a stress is applied to the connection interface. However, according to the present exemplary embodiment, even in case a non-continuous portion is formed on the connection interface, almost no stress is generated due to expansion and contraction because the non-continuous portion is provided with a layer being less in expansion and contraction during insertion and extraction of lithium ion, and thereby, it is also possible to obtain such an excellent effect that a highly reliable column member having n stages can be formed.

As described above, by enhancing the composition ratio (value x) of elements such as near the interface and the end of convex of the current collector in the height direction of a column member formed from SiOx, a column member formed of n stages having a layer being less in expansion and contraction can be manufactured. As a result, even when the column member is repeatedly expanded and contracted in the charge/discharge cycle, a great stress is not generated on the connection interface of the convex of current collector and the column member, and thereby, it is possible to realize a hard-to-peel negative electrode which may assure excellent reliability.

Also, since at least two columnar portions are laminated to form a column member, even in case of equal amount of active material capable of insertion and extraction of lithium ion, the height (thickness) of each columnar portion can be reduced. As a result, each columnar portion becomes less in the amount of expansion as compared with a configuration having one column member. In addition, since the tip portion and the middle portion of the columnar portion are less in the amount of expansion, the interval between adjacent column members is hard to be narrowed, and the column members hardly push against each other. Consequently, the allowable amount against expansion of column members can be greatly increased, and it is possible to enhance the density of column members to be formed on the current collector and to enable the insertion and extraction of much more lithium ion, thereby increasing the battery capacity.

Also, due to the column member formed of n stages of columnar portions, a large space can be maintained between adjacent column members even when the column members are expanded. And, since adjacent column members are hard to come into contact with each other, it is possible to prevent the generation of stresses due to contacting and to prevent resultant creasing of the current collector and peeling off from the current collector. As a result, it is possible to realize a nonaqueous electrolyte secondary battery which is excellent in charge/discharge cycle characteristics.

According to the present exemplary embodiment, a high capacity sustaining ratio can be realized in the charge/discharge cycle while making it possible to enhance the capacity, and it is possible to manufacture a nonaqueous electrolyte secondary battery which is hard-to-peel and excellent in reliability.

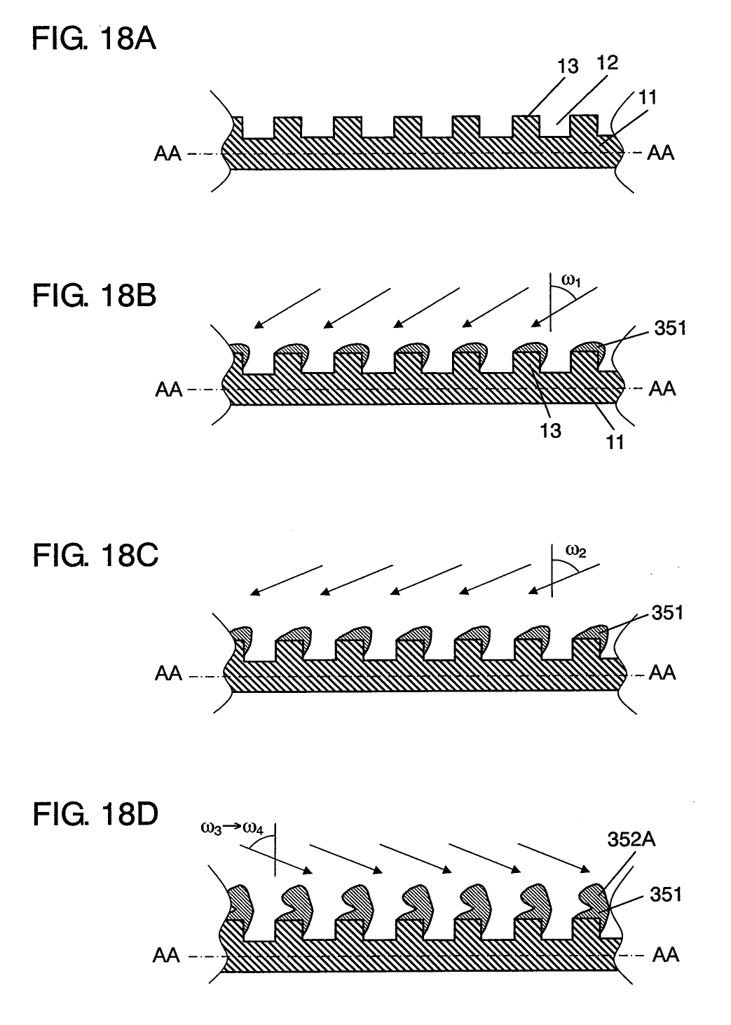

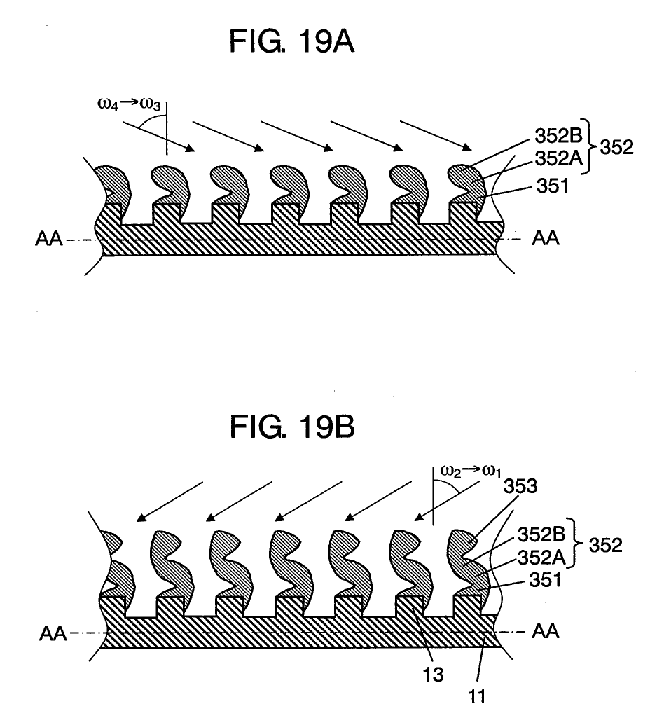

The method of manufacturing a column member of a negative electrode for nonaqueous electrolyte secondary battery in the third exemplary embodiment of the present invention will be described in detail in the following by using FIG. 18A to FIG. 18D, FIG. 19A, FIG. 19B and FIG. 14 while referring to FIG. 16A.

FIG. 18A to FIG. 19B are partially sectional schematic views for describing the method of manufacturing a column member formed of n stages of columnar portions of a negative electrode for nonaqueous electrolyte secondary battery in the third exemplary embodiment of the present invention. Here, the manufacturing apparatus for a negative electrode for nonaqueous electrolyte secondary battery is basically same as in FIG. 14, and it is described with reference to FIG. 14. A column member formed of n=3 stages is described as an example in the following.

Here, as for negative electrode 30 in the present exemplary embodiment, by using manufacturing apparatus 80 shown in FIG. 14, as shown in FIG. 16A, first columnar portion 351 is first formed while current collector 11 moves between masks 82a, 82b which is placed between film depositing rolls 84a, 84b in the direction of going away from the arrow-marked evaporation source 83a shown by a solid line in the figure. Further, second columnar portion A 352A is formed on first columnar portion 351 while current collector 11 moves between masks 82c, 82d which is placed between film depositing rolls 84b, 84c in the direction of coming closer to the arrow-marked evaporation source 83b shown by a solid line in the figure, which is then taken up by take-up roll 85. After that, current collector 11 is delivered from take-up roll 85 again, and while current collector 11 moves between masks 82c, 82d which is placed between film depositing rolls 84b, 84c in the direction of going away from the arrow-marked evaporation source 83b shown by a dotted line in the figure, second columnar portion B 352b is formed on second columnar portion A 352A, and second columnar portion 352 is formed by second columnar portion A 352A and second columnar portion B 352B. And, similarly, while current collector 11 moves between masks 82b, 82a which is placed between film depositing rolls 84b, 84a in the direction of coming closer to the arrow-marked evaporation source 83a shown by a dotted line in the figure, third columnar portion A 353A is formed on second columnar portion 352, which is then taken up by take-up roll 81. After that, current collector 11 is delivered from take-up roll 81 again, and while current collector 11 moves between masks 82a, 82b which is placed between film depositing rolls 84a, 84b in the direction of going away from arrow-marked evaporation source 83a shown by a solid line in the figure, third columnar portion B 353B is formed on third columnar portion A 353A, and third columnar portion 353 is formed by third columnar portion A 353A and third columnar portion B 353B. Third columnar portion 353 is preferable to include only third columnar portion A 353A. That is, the columnar portion at the final stage is not always required to be a pair of columnar portion A and columnar portion B. In this case, in the vicinity of mask 82a, evaporating particles enter the current collector from evaporation source 83a at incident angle ω₁ to the normal line of current collector 11, and in the vicinity of mask 82b, evaporating particles enter the current collector at incident angle ω₂. Accordingly, with the movement of current collector 11, first columnar portion 351 is formed while the incident angle of evaporating particles changes from ω₁ to ω₂. Also, similarly, in second columnar portion 352, firstly, evaporating particles enter the current collector from evaporation source 83b at incident angle ω₃ to the normal line of current collector 11, and with the movement of current collector 11, the incident angle of evaporation particle changes from ω₃ to ω₄ to form second columnar portion A 352A. After that, evaporating particles enter from evaporation source 83b at incident angle ω₄ to the normal line of current collector 11, and with the movement of current collector 11, the incident angle of evaporation particles changes from ω₄ to ω₃ to form second columnar portion B 352B, and in this way, second columnar portion 352 is formed. Further, in third columnar portion 353, firstly, evaporating particles enter from evaporation source 83a at incident angle ω₂ to the normal line of current collector 11, and with the movement of current collector 11, the incident angle of evaporating particle changes from ω₂ to ω₁ to form third columnar portion A 353A. After that, evaporating particles enter from evaporation source 83a at incident angle ω₁ to the normal line of current collector 11, and with the movement of current collector 11, the incident angle of evaporating particle changes from ω₁ to ω₂ to form third columnar portion B 353B, and in this way, third columnar portion 353 is formed.

The status of each columnar portion will be specifically described in the following.

Firstly, as shown in FIG. 18A and FIG. 14, with use of strip-shaped electrolytic copper foil of 30 μm thick, concave 12 and convex 13 are formed by a plating method on the surface thereof, and current collector 11 with convex 13 formed for example by 7.5 μm in height, 10 μm in width, and 20 μm in interval is fabricated (1st step). And, current collector 11 is disposed between delivery roll 81 and take-up roll 85 shown in FIG. 14.

Subsequently, as shown in FIG. 18B and FIG. 14, current collector 11 is moved between film depositing rolls 84a, 84b in the direction of going away from evaporation source 83a while maintaining the specified angle of inclination. In this case, an active material such as Si (scrap silicon: purity 99.999%) from evaporation source 83a is heated and evaporated by means of electron beam in the oxygen atmosphere of pressure 3.5 Pa for example inside the vacuum chamber 86. In this way, evaporating particles enter into the area on convex 13 of current collector 11 from the arrow-marked direction in FIG. 18B.

And, first in the vicinity of mask 82a in an early stage of film forming, with the component of evaporating particle entering at incident angle ω₁ to the normal line of current collector 11 and the oxygen supplied from oxygen intake nozzle 88a near mask 82a, active material SiOx having a composition similar to SiO₂ being larger in value x is formed as a layer being less in expansion and contraction on the interface against convex 13 of current collector 11.

After that, with the movement of current collector 11 from film depositing roll 84a to film depositing roll 84b, first columnar portion 351 grows with evaporating particles while the incident angle changes from ω₁ to ω₂. In this case, in the film forming region where evaporating particle is not shielded by masks 82a, 82b, the number of evaporating particles and the amount of oxygen supplied from oxygen intake nozzles 88a, 88b change according to the distance from evaporation source 83a. That is, when the distance from evaporation source 83a is short, SiOx being smaller in the value of x is formed, and with increase in the distance, SiOx being larger in the value of x is formed. In this way, first columnar portion 351 grows in a state such that the value of x sequentially changes in the direction of width. For example, in FIG. 18B, the value of x becomes smaller at the right-hand side of the figure, and the value of x becomes larger at the left-hand side of the figure.

And, as shown in FIG. 18C and FIG. 14, in the vicinity of mask 82b where the evaporating particle enters at incident angle ω₂, with oxygen supplied from oxygen intake nozzle 88b, first columnar portion 351 film-formed with SiOx having a composition similar to SiO₂ being larger in the value of x as a layer being less in expansion and contraction is formed at the tip portion (2nd step). Particularly, with evaporating particles coming therein when current collector 11 moves under mask 82b, a composition similar to SiO₂ being larger in the value of x is efficiently formed near the tip portion. In this way, first columnar portion 351 of 7.5 μm thick in the oblique direction is formed at angle θ₁ at least on convex 13 of current collector 11.

Next, as shown in FIG. 18D and FIG. 14, between film depositing roll 84c and film depositing roll 84b disposed in a position symmetrical to film depositing roll 84a, current collector 11 with first columnar portion 351 formed thereon is moved while maintaining the specified oblique angle in the direction of coming closer to evaporation source 83b. In this case, an active material such as Si (silicon: purity 99.999%) from evaporation source 83b is heated and evaporated by an electron beam, and the evaporating particle is applied to the tip portion of first columnar portion 351 at incident angle ω₃ in the arrow-marked direction in FIG. 18D.

In that case, the same as in FIG. 18B, in the vicinity of mask 82c, with the component of evaporating particles entering at incident angle ω₃ to the normal line of current collector 11 and the oxygen supplied from oxygen intake nozzle 88c near mask 82c, active material SiOx having a composition similar to SiO₂ being larger in value x is formed as a layer being less in expansion and contraction on the interface against the tip portion of first columnar portion 351 formed on current collector 11.

After that, with the movement of current collector 11 from film depositing roll 84b to film depositing roll 84c, second columnar portion A 352A grows with evaporating particles while the incident angle changes from ω₃ to ω₄. In this case, in the film forming region where evaporating particle is not shielded by masks 82c, 82d, the number of evaporating particles and the amount of oxygen supplied from oxygen intake nozzles 88c, 88d change in accordance with the distance from evaporation source 83b. That is, when the distance from evaporation source 83b is short, SiOx being smaller in the value of x is formed, and as the distance becomes longer, SiOx being larger in the value of x is formed. In this way, second columnar portion A 352A grows in a state such that the value of x sequentially changes in the direction of width. For example, in FIG. 18D, the value of x becomes smaller at the left-hand side of the figure, and the value of x becomes larger at the right-hand side of the figure.

And, in the vicinity of mask 82d where the evaporating particle enters at incident angle ω₄, with oxygen supplied from oxygen intake nozzle 88d, second columnar portion A 352A formed with SiOx having a composition similar to SiO₂ being larger in the value of x as a layer being less in expansion and contraction is formed at the tip portion. Particularly, with evaporating particles coming therein when current collector moves under mask 82d, a composition similar to SiO₂ being larger in the value of x is efficiently formed near the tip portion.

In this condition, in the case of the manufacturing apparatus in the present exemplary embodiment, it is taken up by take-up roll 85.

Next, as shown in FIG. 19A and FIG. 14, current collector 11 formed with first columnar portion 351 and second columnar portion A 352A is again delivered from take-up roll 85 toward delivery roll 81. And, between film depositing roll 84c and film depositing roll 84b, current collector 11 formed with second columnar portion A 352A is moved while maintaining the specified oblique angle in the direction of going away from evaporation source 83b. In this case, an active material such as Si is heated and evaporated from evaporation source 83b by using an electron beam, and thereby, evaporating particle is applied to the tip portion of second columnar portion A352A at incident angle ω₄.

In that case, in the vicinity of mask 82d, with the component of evaporating particles entering at incident angle ω₄ to the normal line of current collector 11 and the oxygen supplied from oxygen intake nozzle 88d near mask 82d, active material SiOx having a composition similar to SiO₂ being larger in value x is formed as a layer being less in expansion and contraction on the interface against the tip portion of second columnar portion A 352A formed on current collector 11.

After that, with the movement of current collector 11 from film depositing roll 84c to film depositing roll 84d, second columnar portion B 352B grows with evaporating particles while the incident angle changes from ω₄ to ω₃. In this case, in the film forming region where evaporating particle is not shielded by masks 82c, 82d, second columnar portion B 352B grows in a state that the value of x sequentially changes in the direction of width. For example, in FIG. 19A, the value of x becomes smaller at the left-hand side of the figure, and the value of x becomes larger at the right-hand side of the figure.

And, in the vicinity of mask 82c where the evaporating particle enters at incident angle ω₃, with oxygen supplied from oxygen intake nozzle 88c, second columnar portion B 352B formed with SiOx having a composition similar to SiO₂ being larger in the value of x as a layer being less in expansion and contraction is formed at the tip portion. Particularly, with evaporating particles coming therein when current collector moves under mask 82c, a composition similar to SiO₂ being larger in the value of x is efficiently formed near the tip portion.

In this way, second columnar portion 352 of 15 μm thick in the oblique angle at θ₂ with second columnar portion A 352A and second columnar portion B 352B which have grown equally with respect to the oblique direction, oblique angle, and changing direction of value x is formed on first columnar portion 351 (3rd step).

Next, as shown in FIG. 19B and FIG. 14, between film depositing roll 84b and film depositing roll 84a, current collector 11 formed with second columnar portion 352 is moved while maintaining the specified oblique angle in the direction of coming closer to evaporation source 83a. In this case, an active material such as Si from evaporation source 83a is heated and evaporated by an electron beam, and the evaporating particle is applied to the tip portion of second columnar portion 352 at incident angle ω₂.

In this case, in the vicinity of mask 82b, with the component of evaporating particles entering at incident angle ω₂ to the normal line of current collector 11 and the oxygen supplied from oxygen intake nozzle 88b near mask 82b, active material SiOx having a composition similar to SiO₂ being larger in value x is formed as a layer being less in expansion and contraction on the interface against the tip portion of second columnar portion 352 formed on current collector 11.

After that, with the movement of current collector 11 from film depositing roll 84b to film depositing roll 84a, third columnar portion 353 grows with evaporating particles while the incident angle changes from ω₂ to ω₁. In this case, in the film forming region where evaporating particle is not shielded by masks 82a, 82b, third columnar portion 353 grows in a state that the value of x sequentially changes in the direction of width. For example, in FIG. 19B, the value of x becomes smaller at the right-hand side of the figure, and the value of x becomes larger at the left-hand side of the figure.

And, in the vicinity of mask 82b where the evaporating particle enters at incident angle ω₂, with oxygen supplied from oxygen intake nozzle 88b, third columnar portion 353 film-formed with SiOx having a composition similar to SiO₂ being larger in the value of x as a layer being less in expansion and contraction is formed at the tip portion. Particularly, with evaporating particles coming therein when the current collector moves under mask 82b, a composition similar to SiO₂ being larger in the value of x is efficiently formed near the tip portion.

In this way, third columnar portion 353 of 7.5 μm thick in the oblique direction at oblique angle θ₃ is formed on second columnar portion B 352B.

Through the above steps, column member 35 having a layer being less in expansion and contraction is formed, wherein first columnar portion 351 and third columnar portion 353 are larger in the value of x at both ends in the height direction than the value in the middle, and second columnar portion 352 is lager in the value of x at both ends and middle in the height direction than other portions. Simultaneously, negative electrode 30 is fabricated having column member 35 of which first columnar portion 351 and third columnar portion 353 are opposite in changing direction of value x to second columnar portion 352 with respect to the width direction of current collector 11, and also different from each other with respect to the oblique angle and the oblique direction.

In the present exemplary embodiment, the third columnar portion has been described by using an example of having one columnar portion, but the present invention is not limited to this. For example, the same as in second columnar portion, as shown in FIG. 16A, it is preferable to configure third columnar portion 353 with third columnar portion A 353A and third columnar portion B353B. That is, in the case of a column member formed of n=3 stages, the columnar portion at the final stage is preferable to be either of a pair of columnar portion A and columnar portion B, and only one columnar portion.

Also, in the present exemplary embodiment, a column member having n=3 stages of columnar portions has been described, but the present invention is not limited to this. For example, by repeating the steps in FIG. 18D to FIG. 19B, it is possible to form a column member having optional n (n≧2) stages of columnar portions.

In the above description, an example of forming the column member on one surface of the current collector has been described, but the present invention is not limited to this. For example, it is preferable to form a column member having a similar configuration on the other surface as well, reversing the current collector. In this way, it is possible to manufacture negative electrodes with excellent productivity.

The embodied examples of the present invention will be specifically described in the following.

### EMBODIED EXAMPLE 1

First of all, a column member of a negative electrode was manufactured by using a manufacturing apparatus shown in FIG. 14.

First, used as a current collector is strip-shaped electrolytic copper foil of 30 μm thick with a convex formed on the surface thereof by a plating method by 7.5 μm in width, 10 μm in height, and 20 μm in interval.

And, Si is used as an active material for the negative electrode, and with use of an evaporation unit (the evaporation source, crucible, and electron beam generator are included in one unit), the first columnar portion formed from SiOx was fabricated by introducing oxygen gas of 99.7% in purity from an oxygen intake nozzle into a vacuum chamber and changing the value of x in the width direction. In this case, the inside of the vacuum chamber is in an oxygen atmosphere of pressure 3.5 Pa. Also, during the evaporation, the electron beam generated by an electron beam generator was deflected by using a deflection yoke and applied to the evaporation source. Scrap material (scrap silicon: purity 99.999%) generated in forming a semiconductor wafer was used as an evaporation source.

Also, the first columnar portion was formed at a film deposition speed of about 8 nm/s, adjusting the specified oblique angle for the movement of the current collector so that the average angle of angles ω₁, ω₂ becomes 60 deg. In this way, the first columnar portion at the first stage (for example, 7.5 μm in height, and 150 μm² in sectional area) was formed. Similarly, by using the forming method described in the exemplary embodiment, the second columnar portion and third columnar portion (for example, 15 μm in height, 150 μm² in sectional area) was formed, thereby forming a column member having three stages. In this case, the third columnar portion includes one columnar portion the same as for the first columnar portion.

The angle to the center line of the current collector of the column member in the negative electrode evaluated through sectional observation by means of a scanning electronic microscope (Hitachi S-4700) is such that oblique angle θ of columnar portion at each stage is on the average about 41 deg. In this case, the thickness (height) of the column member then formed is 30 μm in the normal direction.

Also, the result of investigation of oxygen distribution by measuring the line distribution in the sectional direction of columnar portion at each stage configuring the column member of the negative electrode with the use of EPMA is that the oxygen concentration (value x) is continuously increased in the direction (180-θ) from the oblique angle θ side in the width direction of the first columnar portion and the second columnar portion. And, the increasing directions of oxygen concentration (value x) in the first columnar portion and second columnar portion are opposite to each other. In this case, the range of x is 0.1 to 2, and on the average 0.6.

Also, similarly formed is a layer being less in expansion and contraction wherein in the height direction of the column member, the oxygen concentration (value x) near both ends of the first columnar portion is different from the oxygen concentration (value x) in the middle thereof, while the oxygen concentration (value x) near both ends and in the middle of the second columnar portion and the third columnar portion is different from the oxygen concentration (value x) in other areas. And, in this case, the range of oxygen concentration (value x) near both ends of the first columnar portion is 1.5 to 2, and the range of oxygen concentration (value x) in the middle is 0.1 to 1.5. Similarly, the range of oxygen concentration (value x) near both ends and in the middle of the second columnar portion and the third columnar portion is 1.5 to 2, while the range of oxygen concentration (value x) in other areas is 0.1 to 1.5.

As described above, a negative electrode was manufactured, comprising a column member having a layer being less in expansion and contraction, which is different in oxygen element containing ratio at least in the height direction of each columnar portion.

After that, Li metal of 15 μm was evaporated on the negative electrode surfaces by a vacuum evaporation method. Further, at the inner periphery side of the negative electrode, Cu foil not confronting the positive electrode was provided with an exposed portion, and a negative electrode lead made of Cu was welded thereto.

Subsequently, a positive electrode having a positive electrode active material capable of inserting and extracting lithium ion was manufactured by the same method as for the embodied example 1 in the first exemplary embodiment 1.

By using the negative electrode manufactured as described above, a laminate type battery of 21 mAh in design capacity was manufactured by the same method as for the embodied example 1 in the first exemplary embodiment. This battery is sample 1.

### EMBODIED EXAMPLE 2

A negative electrode was manufactured the same as in the embodied example 1 except that the column member formed has n=4 stages of columnar portions, and the columnar portions at the first stage and fourth stage are 5 μm in height, and columnar portion at the second stage and third stage are about 10 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage and third stage and the columnar portions at the second stage and fourth stage. In this case, the range of x is 0.1 to 2, and on the average 0.6.

Except the use of the above negative electrode, the nonaqueous electrolyte secondary battery manufactured by the same method as for the embodied example 1 is sample 2.

### EMBODIED EXAMPLE 3

A negative electrode was manufactured by the same method as for the embodied example 1 except that the column member formed has n=6 stages of columnar portions, and the columnar portions at the first stage and the sixth stage are about 3 μm in height, and the columnar portions at the second to fifth stages are about 6 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.6.

Except the use of the above negative electrode, the nonaqueous electrolyte secondary battery manufactured by the same method as for the embodied example 1 is sample 3.

### EMBODIED EXAMPLE 4

A negative electrode was manufactured by the same method as for the embodied example 1 except that the column member formed has n=11 stages of columnar portions, and the columnar portions at the first stage and eleventh stage are 1.5 μm in height, and the columnar portions at the second to tenth stages are about 3 μm in height.

The oblique angle of each columnar portion is on the average 41 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first, third, fifth, seventh, and ninth stages and the columnar portions at the second, fourth, sixth, eighth, and tenth stages. In this case, the range of x is 0.1 to 2, and on the average 0.6.

Except the use of the above negative electrode, the nonaqueous electrolyte secondary battery manufactured by the same method as for the embodied example 1 is sample 4.

### EMBODIED EXAMPLE 5

A negative electrode was manufactured by the same method as for the embodied example 3 except that the column member is formed, adjusting the moving angle of current collector so that the average angle of angles ω₁, ω₂ is 50 deg., and the average angle of ω₃, ω₄ is 130 deg.

The oblique angle of each columnar portion is on the average 31 deg., and the thickness (height) of the column member formed is 30 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.6.

Except the use of the above negative electrode, the nonaqueous electrolyte secondary battery manufactured by the same method as for the embodied example 1 is sample 5.

### EMBODIED EXAMPLE 6

A negative electrode was manufactured by the same method as for the embodied example 3 except that the internal pressure of the vacuum chamber is 1.7 Pa in oxygen atmosphere, and the columnar portions at the first and sixth stages are 2.4 μm in thickness, and the columnar portions at the second to fifth stages are 4.8 μm in thickness.

The oblique angle of each columnar portion is on the average 41 deg., and the thickness (height) of the column member formed is 24 μm.

Also, from the measurement of EPMA, in the width direction of each columnar portion, in the direction (180-θ) from the oblique angle θ side, the oxygen concentration (value x) was continuously increased. And, the increasing directions of oxygen concentration (value x) are opposite to each other between the columnar portions at the first stage, third stage, and fifth stage and the columnar portions at the second stage, fourth stage, and sixth stage. In this case, the range of x is 0.1 to 2, and on the average 0.3.

After that, Li metal of 10 μm was evaporated on the negative electrode surfaces by a vacuum evaporation method.

Except the use of the above negative electrode, the nonaqueous electrolyte secondary battery manufactured by the same method as for the embodied example 1 is sample 6.

### COMPARATIVE EXAMPLE 1

A negative electrode was manufactured by the same method as for the embodied example 1 except that the column member is obliquely rising in one stage and 30 μm in height (thickness).

The angle to the center line of the current collector of the column member in the negative electrode evaluated through sectional observation by means of a scanning electronic microscope (Hitachi S-4700) is such that oblique angle of columnar portion is on the average about 41 deg. In this case, the thickness (height) of the column member then formed is 30 μm.

Also, the result of investigation of oxygen distribution by measuring the line distribution in the sectional direction of columnar portion configuring the column member of the negative electrode with the use of EPMA is that the oxygen concentration (value x) was continuously increased in the direction (180-θ) from the oblique angle θ side in the width direction. The range of x is 0.1 to 2, and on the average 0.6.

Except the use of the above negative electrode, the nonaqueous electrolyte secondary battery manufactured by the same method as for the embodied example 1 is sample C1.

With respect to each nonaqueous electrolyte secondary battery manufactured as described above, the battery capacity was measured by the same method as for the second exemplary embodiment, and the charge/discharge cycle characteristic was evaluated.

The items and the evaluation results of sample 1 to sample 6 and sample C1 are shown in Table 5 and Table 6 in the following.

TABLE 5

| | | | | First columnar | | | |
|---|---|---|---|---|---|---|---|
| | Vacuum | | | portion and | Other columnar | Column | Average |
| | level with O₂ | | Oblique | final columnar | portion | member | value of |
| | introduced | n | Angle | portion thickness | thickness | thickness | x of |
| | (Pa) | (stages) | (deg.) | (μm) | (μm) | (μm) | SiOx |
| Sample 1 | 3.5 | 3 | 41 | 7.5 | 15 | 30 | 0.6 |
| Sample 2 | 3.5 | 4 | 41 | 5 | 10 | 30 | 0.6 |
| Sample 3 | 3.5 | 6 | 41 | 3 | 6 | 30 | 0.6 |
| Sample 4 | 3.5 | 11 | 41 | 1.5 | 3 | 30 | 0.6 |
| Sample 5 | 3.5 | 6 | 31 | 3 | 6 | 30 | 0.6 |
| Sample 6 | 1.7 | 6 | 41 | 2.4 | 4.8 | 24 | 0.3 |
| Sample C1 | 3.5 | 1 | 41 | 30 | — | 30 | 0.6 |

TABLE 6

| | Number of | Charge/ | | Capacity |
|---|---|---|---|---|
| | cycles | discharge | High rate | sustaining |
| | (times) | efficiency (%) | ratio (%) | ratio (%) |
| Sample 1 | 10 | 99.8 | 93 | 100 |
| | 500 | 99.8 | 87 | 79 |
| Sample 2 | 10 | 99.8 | 93 | 100 |
| | 500 | 99.8 | 87 | 80 |
| Sample 3 | 10 | 99.8 | 93 | 100 |
| | 500 | 99.8 | 88 | 82 |
| Sample 4 | 10 | 99.8 | 93 | 100 |
| | 500 | 99.8 | 88 | 82 |
| Sample 5 | 10 | 99.8 | 93 | 100 |
| | 500 | 99.8 | 87 | 81 |
| Sample 6 | 10 | 99.8 | 93 | 100 |
| | 500 | 99.8 | 87 | 80 |
| Sample C1 | 10 | 99.8 | 93 | 100 |
| | 500 | 99.2 | 83 | 48 |

As shown in Table 5 and Table 6, in the comparison of sample 1 and sample C1, there is no difference in capacity sustaining ratio in the 10th cycle or so in the initial cycle. However, in the 500th cycle, the capacity sustaining ratio of sample 1 is about 80%, while the capacity sustaining ratio of sample C1 is as low as about 50%. This is probably because there is provided a layer being larger in value x and less in expansion and contraction, of which the active material on the connection interface is nearly equal in element ratio between columnar portions of the column member and inside the column member formed of columnar portion A, columnar portion B, and the layer serves to form an interface that is hard to peel during the charge and discharge.

Thus, it has been confirmed that providing the negative electrode with a column member having a layer being less in expansion and contraction on the connection interface between columnar portions and inside the column member formed of columnar portion A, columnar portion B on the convex of the current collector is effective to improve the cycle characteristic.

Also, as shown in Table 5 and Table 6, in sample 3 and sample 5, it has been found that even with the oblique angle of each columnar portion of the column member changed from 41 deg. to 34 deg., there is almost no difference in capacity sustaining ratio, charge/discharge efficiency, and high rate ratio, and it is possible to obtain excellent characteristics.

Also, as shown in Table 5 and Table 6, in sample 1 to sample 4, it has been found that even with the number of stages of columnar portions of the column member changed, there is almost no difference in capacity sustaining ratio, charge/discharge efficiency, and high rate ratio, and it is possible to obtain excellent characteristics.

Also, as shown in Table 5 and Table 6, in sample 3 and sample 6, it has been observed that when the average value of x of SiOx of the column member is 0.3 and 0.6, sample 6 being smaller in the average value of x tends to become a little lower in capacity sustaining ratio after 500th cycle as compared with sample 3 being larger in the average value of x. This corresponds to the fact that to be smaller in the average value of x is to be greater in expansion and contraction during charge and discharge. Accordingly, it can be considered that the stress or distortion between column members or current collector and columnar portion is increased due to expansion and contraction of the column member, giving rise to the tendency of becoming a little lowered in capacity sustaining ratio.

In the embodied examples in each exemplary embodiment, as active material for column members, examples of using Si, SiOx are described, but there is no particular limit provided that the element is capable of insertion and extraction of lithium ion in a reversible fashion, and for example, it is preferable to use at least one kind of element formed from Al, In, Zn, Cd, Bi, Sb, Ge, Pb and Sn. Further, as an active material, it is allowable to include a material other than the above elements. For example, it is allowable to include transition metal or 2A group element.

In the present invention, the shape and interval of the convex formed on the current collector are not limited to the contents mentioned in each exemplary embodiment, but it is preferable to use any shape provided that it is possible to form an obliquely column member.

Also, the oblique angle formed by the center line of the column member and the center line of the current collector, and the shape and size of the column member are not limited to the above exemplary embodiments, but these are to be properly changed in accordance with the negative electrode manufacturing method and the necessary characteristics of the nonaqueous electrolyte secondary battery used.

1. A negative electrode for nonaqueous electrolyte secondary battery inserting and extracting lithium ion in a reversible fashion, comprising:
a current collector with at least a concave and a convex formed on one surface thereof, and
a column member having n (n≧2) stages of laminated columnar portions obliquely formed on the convex of the current collector,
wherein a layer being less in expansion and contraction due to insertion and extraction of the lithium ion is disposed in the column member.

2. The negative electrode for nonaqueous electrolyte secondary battery of claim 1,
wherein a layer being less in expansion and contraction is disposed near both ends of the columnar portion in the direction of height.

3. The negative electrode for nonaqueous electrolyte secondary battery of claim 1,
wherein a layer being less in expansion and contraction is disposed near the middle of the columnar portion in the direction of height.

4. The negative electrode for nonaqueous electrolyte secondary battery of claim 1,
wherein a layer being less in expansion and contraction is disposed on an outer periphery surface of the columnar portion or a part of outer periphery surfaces of the columnar portions laminated in two or more stages.

5. The negative electrode for nonaqueous electrolyte secondary battery of claim 1,
wherein the layer being less in expansion and contraction which is disposed on the column member is formed by sequentially changing a ratio of contained elements of the column member.

6. The negative electrode for nonaqueous electrolyte secondary battery of claim 1,
wherein a changing direction of the ratio of contained elements in a longitudinal direction of the current collector is different between an even-numbered stage and an odd-numbered stage of the columnar portions of the column member.

7. The negative electrode for nonaqueous electrolyte secondary battery of claim 1,
wherein at least in a state of discharging, n stages of the columnar portions of the column member are obliquely formed on the convex of the current collector, and its odd-numbered stages and even-numbered stages are laminated in a zigzag fashion.

8. The negative electrode for nonaqueous electrolyte secondary battery of claim 1,
wherein at least in a state of charging, an acute angle formed by a center line in oblique direction of the columnar portion and a center line in thickness direction of the current collector is larger than the angle in a state of discharging.

9. The negative electrode for nonaqueous electrolyte secondary battery of claim 1,
wherein a negative electrode active material whose theoretical capacity density for inserting and extracting lithium ion in a reversible fashion at least exceeds 833 mAh/cm³ is used as the column member and the columnar portion.

10. The negative electrode for nonaqueous electrolyte secondary battery of claim 9,
wherein a material represented by SiOx including silicon at least is used as the negative electrode active material.

11. The negative electrode for nonaqueous electrolyte secondary battery of claim 10,
wherein the value of x of the material represented by SiOx including silicon is continuously increased from an acute angle forming side toward an obtuse angle forming side with respect to a crossing angle between a center line in oblique direction of the columnar portion and a center line in thickness direction of the current collector.

12. The negative electrode for nonaqueous electrolyte secondary battery of claim 2,
wherein a layer being less in expansion and contraction is disposed with value x of the material represented by SiOx including silicon increased in the vicinity of both ends or middle in height direction of the columnar portion.

13. The negative electrode for nonaqueous electrolyte secondary battery of claim 4,
wherein a layer being less in expansion and contraction is disposed with value x of the material represented by SiOx including silicon increased at an outer periphery surface of the columnar portion.

14. A method of manufacturing a negative electrode for nonaqueous electrolyte secondary battery inserting and extracting lithium ion in a reversible fashion, comprising:
a first step of forming at least a concave and a convex on one surface of a current collector;
a second step of obliquely forming a first stage columnar portion on the convex while moving the current collector in a direction of increasing an angle formed by an evaporation source and the normal line of the current collector; and
a third step of forming a second stage columnar portion obliquely rising in a direction different from the oblique direction of the first stage columnar portion while moving the current collector in a direction of decreasing the angle,
wherein the second step and the third step are repeated twice at least to form a column member formed of n (n≧2) stages which are different in oblique direction of the columnar portion between an odd-numbered stage and an even-numbered stage, and
at least any one of the steps for forming the columnar portions includes a step of forming a layer being less in expansion and contraction due to insertion and extraction of lithium ion.

15. The method of manufacturing a negative electrode for nonaqueous electrolyte secondary battery of claim 14,
wherein the layer being less in expansion and contraction is formed near both ends in height direction of the columnar portion.

16. The method of manufacturing a negative electrode for nonaqueous electrolyte secondary battery of claim 14,
wherein the layer being less in expansion and contraction is formed near a middle portion in height direction of the columnar portion.

17. The method of manufacturing a negative electrode for nonaqueous electrolyte secondary battery of claim 14,
wherein the layer being less in expansion and contraction is formed on an outer periphery surface of the column member or a part of outer periphery surfaces of the columnar portions laminated in two or more stages.

18. The method of manufacturing a negative electrode for nonaqueous electrolyte secondary battery of claim 14,
wherein the angle changing direction of the current collector against the evaporation source is different between the odd-numbered stage and the even-numbered stage.

19. A nonaqueous electrolyte secondary battery, comprising:
the negative electrode for nonaqueous electrolyte secondary battery of claim 1,
a positive electrode for inserting and extracting lithium ion in a reversible fashion, and
nonaqueous electrolyte.

20. The negative electrode for nonaqueous electrolyte secondary battery of claim 6,
wherein at least in a state of discharging, n stages of the columnar portions of the column member are obliquely formed on the convex of the current collector, and its odd-numbered stages and even-numbered stages are laminated in a zigzag fashion.

21. The negative electrode for nonaqueous electrolyte secondary battery of claim 6,
wherein at least in a state of charging, an acute angle formed by a center line in oblique direction of the columnar portion and a center line in thickness direction of the current collector is larger than the angle in a state of discharging.

22. The negative electrode for nonaqueous electrolyte secondary battery of claim 3,
wherein a layer being less in expansion and contraction is disposed with value x of the material represented by SiOx including silicon increased in the vicinity of both ends or middle in height direction of the columnar portion.
